(19) United States
(12) Patent Application Publication
(10) Pub. No.: US 2026/0127386 A1
(43) Pub. Date: May 7, 2026

(54) LANGUAGE MODEL THEORY SOLVERS

(71) Applicant: Amazon Technologies, Inc., Seattle, WA (US)

(72) Inventors: Umberto Maria Tomasini, Lausanne (CH); Luca Zancato, Pasadena, CA (US); Alessandro Achille, Arcadia, CA (US); Stefano Soatto, Pasadena, CA (US); Aditya Sharad Golatkar, Los Angeles, CA (US); Greg Ver Steeg, Los Angeles, CA (US); Wei Xia, Bellevue, WA (US)

(21) Appl. No.: 18/979,947

(22) Filed: Dec. 13, 2024

Related U.S. Application Data
(60) Provisional application No. 63/715,193, filed on Nov. 1, 2024.

(51) Int. Cl. G06F 40/40; G06F 16/334

(52) U.S. Cl. CPC G06F 40/40; G06F 16/3344

(57) ABSTRACT

Techniques for processing a natural language query using an SMT solver that includes an LLM. The LLM processes the query text to formalize constraint text into pseudo code, which is processed by an SAT solver to determine logical atoms and propositional model for solving the query. The LLM then acts as a theory solver within the SMT solver to process the logical atoms and determine a valid solution for the natural language query.

### CROSS-REFERENCE TO RELATED APPLICATIONS

This application claims the benefit of priority under 35 U.S.C. § 119 (e) to Provisional U.S. Application No. 63/715,193, filed Nov. 1, 2024, entitled “LANGUAGE MODEL THEORY SOLVERS”, in the names of Umberto Maria Tomasini, et al. The contents of the foregoing application is hereby incorporated herein by reference in its entirety.

### BACKGROUND

A solver is a software engine that can apply logical reasoning to answer a question. For example, a solver may determine whether a given formula or logical expression is satisfiable (“SAT”) or unsatisfiable (“UNSAT”). In a Boolean satisfiability problem, a logical expression is said to be SAT if the variables of the logical expression can be replaced by the values TRUE or FALSE in such a way that the logical expression equates to TRUE; if not, the problem is UNSAT. In mathematical logic, a formula is said to be SAT if values (e.g., numbers) can be assigned to the variables and/or interpretations assigned to functions and constants to make the formula TRUE. Multiple solvers may be implemented in a portfolio such that a central manager can send the same problem to multiple solvers. The solvers may attempt to solve the problem and return a result to the central manager, which may send the result to the requesting system or user.

### BRIEF DESCRIPTION OF THE DRAWINGS

The detailed description of certain embodiments of the invention are understood with reference to the following figures:

FIGS. 1A-1B illustrate a system and a method for language model theory solvers, according to an embodiment.

FIG. 2 is a flowchart of a sub-method for using a user input and a language model generated answer to determine one or more input variable constraints and one or more output variable constraints, according to an embodiment.

FIG. 3 is a flowchart of a sub-method to generate sets of formal logic constraints, according to an embodiment.

FIG. 4 is a flowchart of a sub-method for selecting a particular formal logic constraint(s) for validating the language model generated answer to a user input, according to an embodiment.

FIG. 5 is a flowchart of a sub-method for performing a satisfiability check of the particular formal logic constraint(s) under the one or more constraints, according to an embodiment.

FIG. 6 is a flowchart of a sub-method for using a language model as a theory solver, according to an embodiment.

FIG. 7 is a conceptual diagram illustrating example components of a system configured to use a language model to determine a response to a user input, according to embodiments of the present disclosure.

FIG. 8 is a conceptual diagram illustrating example processing of the system configured to use a language model, according to embodiments of the present disclosure.

FIG. 9 illustrates an example multi-tenant provider network environment in which the techniques disclosed herein for language model theory solvers may be implemented.

FIG. 10 is a block diagram of an example multi-tenant provider network that provides a storage service and a hardware virtualization service to customers and in which the techniques disclosed herein for language model theory solvers may be implemented.

FIG. 11 illustrates an example of a programmable electronic device that processes and manipulates data to perform tasks and calculations disclosed herein for language model theory solvers.

FIG. 12 illustrates an example transformer model architecture that may be used in an implementation of a language model, according to some embodiments of the present disclosure.

### DETAILED DESCRIPTION

Some techniques to perform automated reasoning on language-based tasks employ formal solvers. These solvers may require a formalization of the task, which can be rather cumbersome and sometimes unfeasible for natural language queries.

A solver is a software engine that can apply logical reasoning to answer a question. A solver may implement one or more algorithms to solve a problem such as a Boolean satisfiability problem. An algorithm may specify a search procedure for exploring a space of possible variable assignments. In some cases, the algorithm may reduce the search space by using a backtracking and/or backjumping technique for building candidate solutions and abandoning a candidate if the candidate cannot possibly be completed to a valid solution, where backtracking may refer to going up one level in the search tree when the candidate is eliminated, and backjumping may refer to going up two or more levels. Solver types in common usage may include local-search, conflict-driven clause learning (CDCL), and look-ahead. Solvers may be used in, for example, mathematics to assist in proving mathematical theorems, software verification to check whether a program performs to specification, hardware verification to check whether a finite-state system performs to specification, and operations research to solve optimization and scheduling problems. Solvers may be implemented in cloud computing architectures where they can leverage vast computing resources (e.g., processor power and/or memory space) that enable them to solve complex problems.

A language model, such as a large language model (LLM), is a type of artificial intelligence system that is trained on vast amounts of text data to understand and generate human-like language in response to an input prompt. Language models use deep learning algorithms, specifically neural networks, to learn patterns and relationships within the training data, enabling them to make predictions about language based on the context provided. These models can perform various natural language processing tasks, such as text generation, language translation, question answering, and sentiment analysis. A language model analyzes an input prompt and generates an answer or response based on its training and understanding of the prompt.

LLMs are capable of producing coherent and contextually relevant text, making them useful tools in applications like chatbots, content creation, and virtual assistants. As the name suggests, LLMs are characterized by their large size, often containing billions of parameters, which allows them to capture and learn from the intricacies and nuances of human language. Some well-known examples of LLMs include GPT (Generative Pre-trained Transformer) models, BERT (Bidirectional Encoder Representations from Transformers), and XLNet.

In some embodiments, the language model(s) may include transformer-based sequence to sequence (seq2seq) models involving an encoder-decoder architecture. In an encoder-decoder architecture, the encoder may produce a representation of an input (e.g., audio, text, image, video, etc.) using a bidirectional encoding, and the decoder may use that representation to perform some task. In some such embodiments, one or more of the language models may be a multilingual (approximately) 20 billion parameter seq2seq model that is pre-trained on a combination of denoising and Causal Language Model (CLM) tasks in various languages (e.g., English, French, German, Arabic, Hindi, Italian, Japanese, Spanish, etc.), and the language model may be pre-trained for approximately 1 trillion tokens. Being trained on CLM tasks, the language model(s) may be capable of in-context learning. Examples of such language models include some of the Amazon Alexa and Amazon Web Services (AWS) Titan family of generative models.

In other embodiments, the language model(s) may be a decoder-only architecture. The decoder-only architecture may use left-to-right (unidirectional) encoding of the input (e.g., audio, text, image, video, etc.). Examples of such language models include others in the Amazon Alexa and AWS Titan family of models as well as the Generative Pre-trained Transformer 3 (GPT-3), GPT-4, and other versions of GPT. GPT-3 reportedly has a capacity of (approximately) 175 billion machine learning parameters. GPT-4 reportedly has a capacity of (approximately) 1.76 trillion machine learning parameters.

Other examples of language models include BigScience Large Open-science Open-access Multilingual Language Model (BLOOM), Language Model for Dialogue Applications model (LaMDA), Bard, Large Language Model Meta AI (LLaMA), etc.

Language models (e.g., LLMs) can perform informal reasoning tasks and use expansive large knowledge bases without needing to formalize them. However, some language models on their own may fail in complex reasoning tasks with one or more constraints. For example, if a user asks a system (implementing a language model) for help in planning a trip, the system should reply by taking into consideration both the given hard constraints and other unspecified common-sense constraints like “not visiting the same attraction every day” or “keep my budget to $25 per person.” These are tasks at which a language model may struggle, as it may fail to satisfy certain constraints, both hard and common sense/implied constraints, especially as those constraints increase in number and complexity. A language model may particularly struggle with constraints that involve mathematical statements (for example, budget constraints). In satisfiability problems, even robust language models may fail to satisfy all constraints.

Solvers, however, can excel in formal reasoning. To perform formal reasoning, a system may utilize Satisfiability Modulo Theories (SMT): a set of problems that generalize Boolean Satisfiability (SAT) problems. Specifically, an SMT is the problem to understand whether a given statement in the language of a given mathematical theory (e.g., theory of inequalities or theory of bit vectors) is true/false/unknown. An example of a SMT is to decide whether there exist possible values of x,y,z such that they satisfy the following statement:

x*z=y∧(z<0∨y=0).
SMT solvers are tools that can solve these classes of formal problems and can be used in applications such as automated theorem proving and software testing.

In some cases, using SMT solvers for automated reasoning on natural language may require a cumbersome formalization procedure, which sometimes can be as difficult as solving the problem itself. This formalization may involve organizing all the knowledge related to the natural language query with a precise ontology. As an example, consider that a given premise that “all dogs sleep” and the system has to decide whether the conclusion “at least one animal sleeps” is true. To answer using a SMT solver a system may need to introduce the entailment “all dogs are animals.” As can be appreciated, such an ontology creation can quickly scale up to become a complicated and lengthy problem as more concepts (e.g., constraints, variables, etc.) are included in the query. Knowledge graphs may be developed to track such information but they can become large and unmanageable depending on the amount of information they are intended to catalog. Further, in some cases, natural language reasoning can be fuzzy, not easy to formalize, and may involve implied common sense reasoning that is not explicit in a query or in a formal knowledge storage. For example, to address the query “I want a pet. Should I get a hyena or a cat?” a SMT solver would need to be configured to define many concepts using common sense information. Thus, an approach to perform formal reasoning based on knowledge bases/graphs also involves spending significant time and resources in formalizing each detail to be used by the solver (which is not always feasible), in order for a solver to treat an incoming query as a formal proving problem.

Disclosed herein are systems, methods, and non-transitory computer-readable media (generally, “techniques”) for using language models (or other types of generative models) to complement SMTs for automated reasoning. In particular, techniques are presented for combining and arranging operations of language model and SMT processing to more accurately process constraints so as to improve accuracy with respect to incoming user queries. While other systems may use an LLM to formalize a question and then ask a logical solver to solve it, the present disclosure relates to, among other things, using an LLM as the solver itself, which may involve giving the model the task of determining value(s) for variable(s) in a user query and determining a solution thereto. The solution may be subject to additional checks. The operations described herein may be performed with a general purpose language model (such as those described above) but may also be performed with a domain/subject matter specific language model, for example a model trained to handle travel queries, food queries, entertainment queries, etc.

As language models excel at translation tasks and inherently include information akin to a large knowledge base (by virtue of the training of the model), the system may use language models to perform a formalization step from natural language to logic language. The system may use SMTs for formal reasoning while being supported by language models to understand the informal (e.g., natural language) user queries, leveraging the model's built-in knowledge.

In an embodiment, the techniques encompass an approach in a multi-tenant provider network 102. The approach proceeds by obtaining a natural language query and processing it with a language model. First, a language model may process the query to identify and formally re-state any constraints within the query. The formalized restatements are processed with another component to express the constraints in logically distinct sections. A natural language recitation of those expressions is then sent to the language model (or to a different model) to attempt to solve the query, that is to find values for the variables expressed in the query. These processes may be part of a generative AI assistant service 118, automated reasoning service 120, or other service.

When a user input and a language model-generated answer are received from a client via an intermediate network, a generative AI assistant service 118 in the provider network selects a relevant set of formal logic constraints and determines input and output variable constraints based on the user prompt and LLM-generated answer. An automated reasoning service 120 in the provider network may then perform a satisfiability check on the selected formal logic constraints under the determined variable constraints. Based on the result of the satisfiability check, the generative AI assistant service 118 generates a response to the user prompt and provides it to the client via the intermediate network.

A beneficial technical effect of the approach is the improvement of the accuracy and reliability of responses generated by language models and their built-in understanding of the flexibility of language. As mentioned, language models are useful tools for generating human-like text based on patterns learned from vast amounts of data. They can be used to translate natural language constraints into formal language for processing by a formal solver which determines a logical recitation of a potential solution to the query, which can then be passed back to the language model for solving. Here, the combination of operations of an SAT solver to identify the logical items to be solved and the language model solver, allows for improved processing of inputs such as natural language queries.

An SMT solver is made possible by a SAT solver followed by a theory solver. As used herein, a “satisfiability problem” may include a Boolean or mathematical logic problem. Such formulas may be expressed using formalisms such as, for example, DIMACS, SMT-LIB, or the like; however, the system is not limited to any particular formalism or expression. Consider a math statement like the following. The SMT solver finds values of a, c, and d that satisfy:

g(a)=c∧f(g(a))≠f(c)∨g(a)=d∧c≠d
The above statement may be divided into logical atoms like 1:=“g (a)=c”, 2̅:=f(g(a))!=f(c), 3:=g (a)=d, and 4̅:=c!=d. Logical atoms are sub-parts of a logical statement that represent a minimal portion of the logical statement that can be evaluated on its own. The SAT solver may process the logical atoms and indicate which logical atoms should be satisfied to make the whole statement true, for example 1∧2̅∧4̅. Then the theory solver finds values of a, c, and d that satisfy the selected atoms, using the theory that it knows, thus determining a model of the result.

Offered is a system that substitutes the theory solver with a language model for natural language problems, thus using the inherent “theory” of language configured into the model. The language model (or another model) may also be used to perform auto-formalization to expressly recite certain constraints in a more logical format.

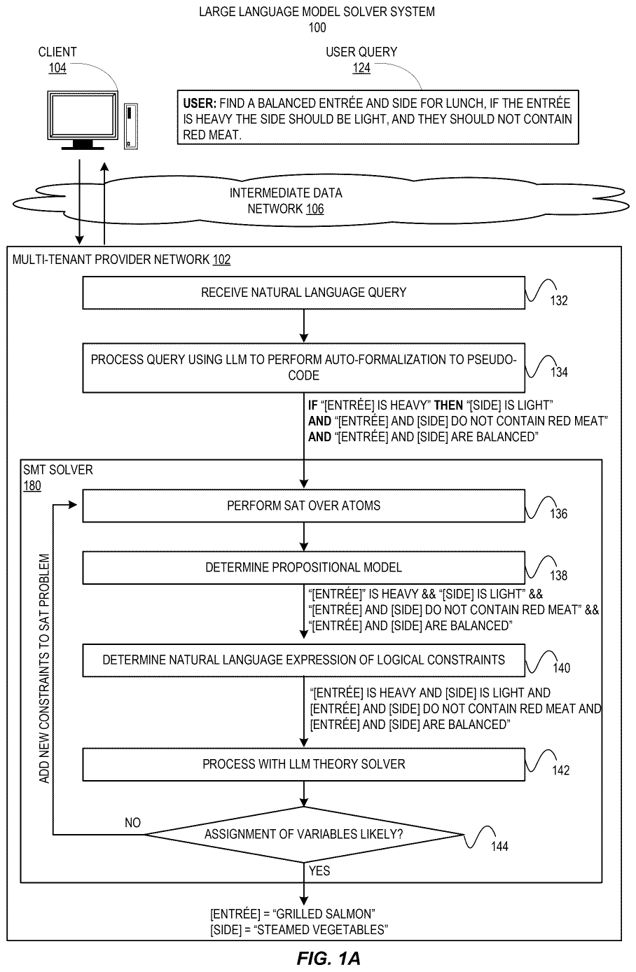

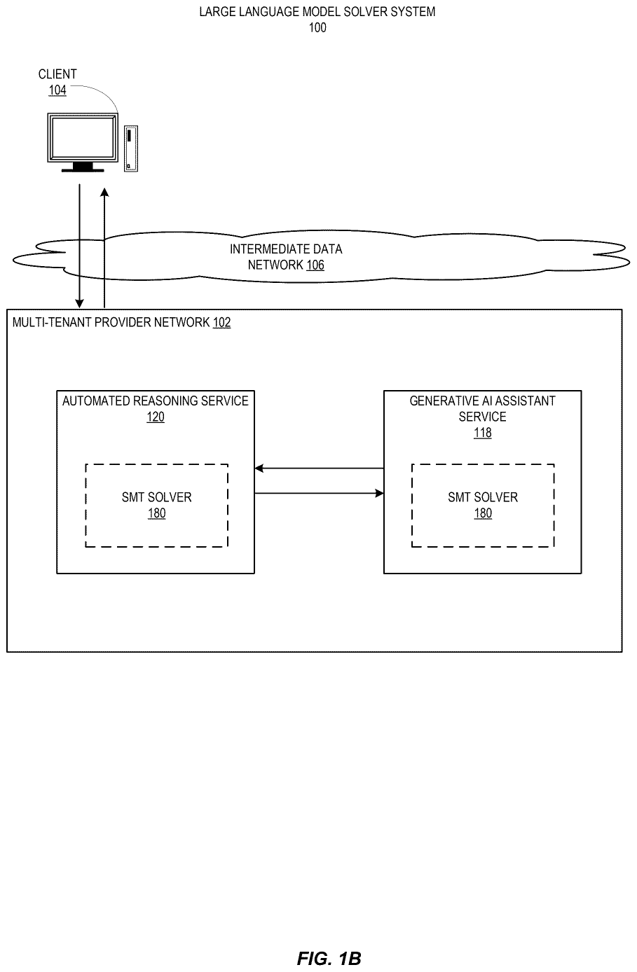

FIGS. 1A-1B illustrate a system and a method for using one or more language models as a theory solver and also for identifying and processing constraint information, according to an embodiment. The system exists in the context of a language model (e.g., LLM) solver system 100 that includes a multi-tenant provider network 102 and one or more clients (e.g., client 104) that are connected to the multi-tenant provider network 102 via an intermediate network 106.

The multi-tenant provider network 102 is a cloud computing environment that offers various services to multiple clients or tenants. This network 102 hosts a variety of services and components, including one or more LLMs, an SMT solver 180, and others. As shown in FIG. 1B, the SMT solver 180 may be part of another service such as a generative AI assistant service 118, automated reasoning service 120, natural language text-to-programming language code translation service, and/or other service (not shown). The SMT solver 180 may include components for processing logical statements. Example SMT solvers include a Z3 Theorem Prover, cvc5 (cooperating validity checker), or other solver configurations.

The intermediate network 106 (e.g., the internet) acts as a communication channel between the client 104 and the multi-tenant provider network 102. It enables the client 104 to interact with the services provided by the multi-tenant provider network 102, such as submitting user prompts and receiving generated responses. The intermediate network 106 may include various networking components, such as routers, switches, and gateways, to facilitate the secure and efficient transmission of data between the client 104 and the multi-tenant provider network 102.

The client 104 is an entity, such as an individual user or an organization, that utilizes the services offered by the multi-tenant provider network. The client 104 interacts with the multi-tenant provider network 102 through the intermediate network 106 by submitting user prompts and receiving generated responses.

In the multi-tenant provider network environment 102, the client 104 is representative of one of potentially many clients that may utilize the services offered by the multi-tenant provider network 102. In an embodiment, the term “multi-tenant” means that the provider network 102 is designed to serve multiple clients or tenants simultaneously, each with their own unique requirements and workloads.

The client 104 is just one example of the many clients that can interact with the multi-tenant provider network 102 through the intermediate network 106. These clients may include individual users, small businesses, large enterprises, or other organizations that require access to the specialized services hosted within the multi-tenant provider network 102, such as the SMT solver 180.

Each client can have its own set of user prompts and specific needs for language model generated answers/queries to be solved. The multi-tenant provider network 102 may be designed to handle these varied requirements by providing a shared infrastructure and resources that can be efficiently allocated and scaled to meet the demands of multiple clients concurrently. The intermediate network 106 enables these clients to securely communicate with the multi-tenant provider network 102 and access the services they need.

From the perspective of the multi-tenant provider network 102, the client 104 is treated as one of many clients, each with their own isolated environment and data. The provider network 102 ensures that the resources and services are properly provisioned and managed to maintain the performance, security, and privacy of each client's workloads, while still allowing for efficient sharing of underlying infrastructure.

The client 104 encompasses a personal computing device that is used to interact with the services offered by the multi-tenant provider network 102. This personal computing device serves as the primary interface through which the client 104, whether an individual user or an organization, accesses and utilizes the resources and services provided by the multi-tenant provider network 102.

The personal computing device can take various forms, such as a desktop computer, laptop, tablet, smartphone, or any other device capable of connecting to the intermediate network 106 and running the software or applications to communicate with the multi-tenant provider network 102. The device is equipped with a web browser, dedicated application, or application programming interface (API) client that enables the client 104 to send requests, submit user prompts, and receive responses from the services hosted within the multi-tenant provider network.

When the client 104 wants to use a service that uses the SMT solver 180 or any other service offered by the multi-tenant provider network 102, they initiate the interaction through their personal computing device. The device establishes a connection to the intermediate network 106, which acts as a bridge between the client 104 and the multi-tenant provider network 102. The intermediate network 106 facilitates the secure transmission of data, such as user prompts and generated responses, between the client 104's personal computing device and the relevant services within the multi-tenant provider network 102.

A generative AI assistant service 118 within the multi-tenant provider network 102 may offer a chatbot service to the client 104. The chatbot service is powered by artificial intelligence (AI) technologies, particularly language models (e.g., LLMs) such as language model 745 discussed below and/or other types of generative models, and enables the client 104 to engage in interactive conversations and receive intelligent, contextualized responses to their inquiries or prompts.

When the client 104 accesses the generative AI assistant service 118 through their personal computing device, they can input natural language queries, questions, or prompts related to various topics or domains (e.g., user query 124). The generative AI assistant service 118 processes these user inputs using advanced natural language processing techniques and AI algorithms.

At the core of the generative AI assistant service 118 is, in some embodiments, one or more large language models (LLMs), which are artificial intelligence (AI) models trained on vast amounts of textual data. These models can understand and interpret the meaning and context of user inputs, allowing them to generate coherent and relevant responses. The LLM or LLMs employed by the generative AI assistant service 118 can draw upon their extensive knowledge base to provide informative, engaging, and contextually appropriate responses to the client 104's queries.

The generative AI assistant service 118 utilizes these LLM(s) to analyze the client's 104 input, understand the intent behind their message, and formulate an intelligent response. The LLM(s) can generate human-like text based on the input prompt, taking into account the context of the conversation and the specific requirements of the client 104. This enables the generative AI assistant service 118 to provide personalized and dynamic responses tailored to the client 104's needs.

Other services, such as an automated reasoning service 120, may similarly use LLMs and/or other generative models. To further enhance the accuracy and reliability of the generative AI assistant service 118 responses, the generative AI assistant service 118 (or other service) may incorporate additional techniques, such as the use of SMT solvers to parse and process incoming user queries.

An automated reasoning service 120 (or other service) of the multi-tenant provider network 102 may be responsible for performing satisfiability checks on formal logic constraints. The purpose of a satisfiability check is to validate an LLM-generated answer to a user prompt against logical constraints derived from relevant text chunks.

The automated reasoning service 120 may include a specialized service that uses algorithms and techniques from the field of formal logic and automated theorem proving. It takes as input a particular set of formal logic constraints, along with input and output variable constraints determined based on a user prompt and the LLM-generated answer to the user prompt. These constraints represent the logical relationships and requirements that the LLM-generated answer must satisfy to be considered valid and consistent with the underlying procedural knowledge.

The satisfiability check performed by the automated reasoning service 120 may involve analyzing the formal logic constraints and the variable constraints to determine if there exists a set of variable assignments that satisfies all the constraints simultaneously. In other words, it checks whether the LLM-generated answer is logically consistent with the constraints derived from the procedural text chunks.

To perform this check, the automated reasoning service 120 uses algorithms, such as satisfiability modulo theories (SMT) solvers or constraint satisfaction problem (CSP) solvers. These algorithms systematically explore the space of possible variable assignments, considering the logical relationships and constraints imposed by the formal logic constraints and the variable constraints. If a satisfying assignment is found, it means that the LLM-generated answer is consistent with the procedural knowledge, and the satisfiability check returns a positive result.

The result of the satisfiability check may then be sent to the generative AI assistant service 118, which uses this information to generate an appropriate response to the user prompt. If the satisfiability check is successful, the response can indicate that the LLM-generated answer is valid and supported by the procedural knowledge. If the satisfiability check fails, the response can highlight the inconsistency and suggest alternative answers or prompt the user for further clarification.

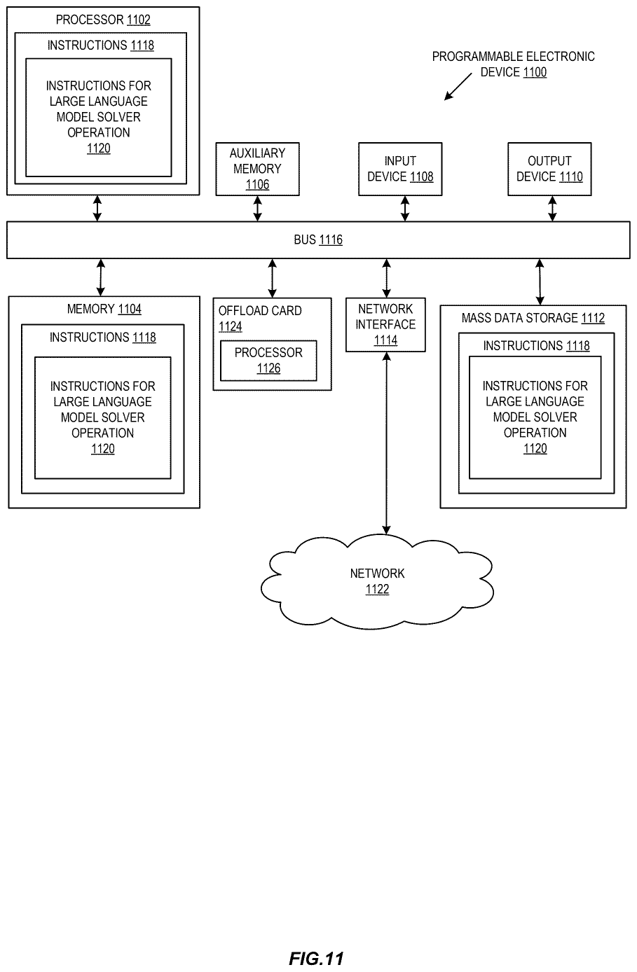

In an embodiment, the method is performed by a set of programmable electronic devices (e.g., programmable electronic device 1100 of FIG. 11) in a multi-tenant provider network (e.g., multi-tenant provider network 102). However, the method may be performed by a single programmable electronic device. Furthermore, the method may be performed in other contexts such as by one or more programmable electronic devices in an on-premises or enterprise context or by a set of programmable electronic devices in a hybrid context where some of the steps are performed by one or more programmable electronic devices in an on-premises or enterprise context and some steps are performed by one or more electronic devices in a multi-tenant provider network.

At a high-level, the method encompasses an approach for using language models (e.g., LLMs) to process a natural language query to determine constraints in the query and to formalize them, and to use the language models as theory solvers for solving problems in the context a multi-tenant provider network 102.

FIG. 1A shows such operations in the context of a client 104 submitting a particular user query 124 to the multi-tenant provider network 102. The user query 124 represents an input or query provided by a client 104, typically in natural language form. The client 104 interacts with a generative AI assistant service 118 (or other service) through an intermediate network 106 that connects the client 104 to the multi-tenant provider network 102. This intermediate network 106 acts as a communication channel, allowing the client 104 to send the user query 124 to the AI assistant service 118.

The representation of the user query 124 input to a processing model can take different forms at the generative AI assistant service 118 depending on the interaction between the user and the generative AI assistant service 118. In some cases, a prompt to the LLM may encompass just the most recent user input in an ongoing conversation between the user and the AI agent. This means that the prompt represents the latest message or query provided by the user, without including any previous conversation history. Thus, in one example, the prompt may simply be limited to the specific question of the user query. However, in other scenarios, the prompt may encompass a more extensive conversation history, including several recent user inputs and potentially the AI agent's responses, profile information of the user, supplemental data regarding the query, etc. This approach allows for a contextual understanding of the user's intent and helps in providing accurate and coherent answers.

Furthermore, the user query 124 may be augmented or rewritten by the generative AI assistant service 118 itself to enhance the context and facilitate subsequent processing. This augmentation process can involve various techniques, such as adding relevant keywords or phrases to the user prompt context to improve retrieval accuracy, rephrasing the user prompt context to clarify the user's intent or to align it with the terminology used in the programming language codes, expanding the user prompt context with additional information from the conversation history or from external knowledge sources to provide a more comprehensive context, or breaking down complex prompts into smaller, more focused sub-prompts to enable more targeted retrieval and generation. By augmenting or rewriting the user prompt 124, the generative AI assistant service 118 can enhance the quality and relevance of the retrieved programming language codes and the generated responses. It allows the service 118 to better understand the user's intent, provide more accurate answer, and offer explanations that are tailored to the user's needs.

For FIG. 1A, the example user query 124 may be as follows: “Find a balanced entree and side for lunch. If the entree is heavy the side should be light, and they should not contain red meat.” The multi-tenant provider network 102 may receive (132) the natural language query and then process (134) the natural language query using an LLM to perform auto-formalization, converting the natural language query constraints to pseudo-code/conditional statement(s). These constraints are specifically applied to the corresponding input and output variables of the particular set of formal logic constraints selected as described below.

The purpose of determining these constraints is to establish the specific conditions and limitations that the input and output variables must satisfy in order to properly respond to the user query 124.

To determine the input variable constraints, the generative AI assistant service 118 analyzes the user query 124 and extracts, using the LLM, relevant information that can be used to constrain the input variables of the selected formal logic constraints. This may involve identifying specific values, ranges, or conditions mentioned in the user query 124 that relate to the input variables. For example, if the user query 124 mentions a specific number or a certain condition, the LLM can use that information to create constraints on the corresponding input variables.

The process of determining these constraints involves a combination of natural language processing techniques and domain-specific knowledge. The generative AI assistant service 118 may employ techniques such as named entity recognition, dependency parsing, or semantic analysis to extract the relevant information from the user query 124. It may also leverage domain-specific ontologies, rules, or patterns to map the extracted information to the appropriate input and output variables of the selected formal logic constraints.

To determine the constraints, the system may generate a representation of the user query to input to the LLM in the form of a prompt. For example, the system 100 may construct a prompt to the LLM such as:
{Here is an input user query:
“Find a balanced entree and side for lunch. If the entree is heavy the side should be light, and they should not contain red meat.”
Find any constraints in the user query and identify those constraints and any variables that depend on the constraints. Then output a formal restatement of those constraints in a pseudo-code [or logically processable] format.}

The LLM may then output text along the lines illustrated in FIG. 1A following step 134, where the input user query is broken out by variables and constraints in a logical statement. For example, the LLM may output text along the lines of:

IF “[entrée] is heavy” THEN “[side] is light”
AND “[entrée] and [side] do not contain red meat”
AND “[entrée] and [side] are balanced”

Where IF, THEN, and AND are indicators of logical operands that a downstream component (such as an SAT component) may understand. Further, items in brackets such as “[entrée]” and “[side]” may indicate placeholders for variables whose values are to be determined by a downstream component, for example an LLM solver.

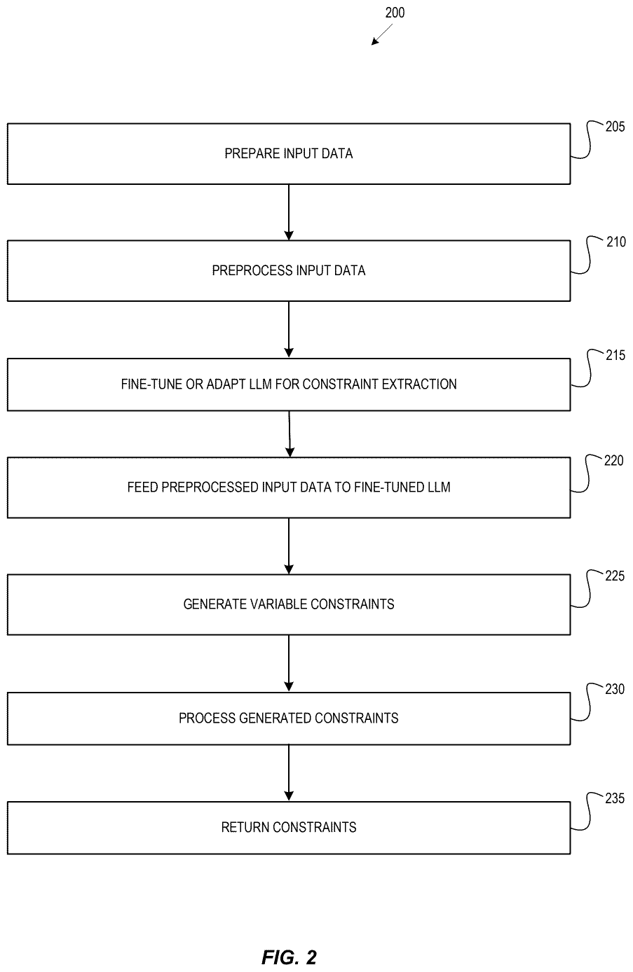

In one example, the LLM may determine constraints according to the operations illustrated in FIG. 2. FIG. 2 is a flowchart of a sub-method 200 for using the user prompt (e.g., user query, user input) to determine a set of one or more input variable constraints (and potentially a set of one or more output variable constraints), according to an embodiment. The sub-method 200 uses a language model (e.g., a LLM) to determine the input (and/or output) variable constraints from the user prompt. The sub-method 200 may be performed as part of Step 134 to determine pseudo-code representing the constraints of user query 124.

At Step 205, the input data is prepared. The user prompt is prepared into an input string. At Step 210, the input data is preprocessed. The input string is tokenized into individual words or subwords. Text normalization techniques are performed, such as lowercasing, removing punctuation, and handling special characters. Any domain-specific preprocessing steps are applied, such as replacing technical terms or acronyms with their expanded forms.

At Step 215, an LLM is fine-tuned or adapted for constraint extraction: A pre-trained LLM is selected that is suitable for text understanding and generation tasks, such as GPT-3, BERT, or T5. b. The LLM is fined-tuned or adapted on a dataset specifically designed for extracting input variable constraints from user prompts. The fine-tuning dataset may include examples of user prompts, generated answers, and their corresponding input and output variable constraints. The LLM is trained to learn the patterns and relationships between the input data and the desired constraints. The Step 215 may be performed prior the Steps 210 and 205 (for example during offline or training operations).

At Step 220, the preprocessed input data is input to the fine-tuned LLM. The preprocessed input string is passed to the fine-tuned LLM. The LLM may process the input data and generate output based on its trained understanding of extracting variable constraints.

At Step 225, the input variable constraints are generated. The fine-tuned LLM analyzes the input data and generates the input variable constraints as its output. The generated constraints may be in a structured format, such as a dictionary or a formatted string, that specifies the constraint(s) for a variable. The LLM may generate constraints based on the values, ranges, or conditions mentioned in the user query 124 or the pre-processed input data, as well as the data types, parameter names, or the like.

In an embodiment of step 225 of the sub-method 200, the fine-tuned LLM can be prompted to construct logical formulas over constraints using the user query 124. These logical formulas serve to bound and/or relate the constraints, providing an expressive and precise representation of the relationships between the input and possibly output variables.

Instead of simply generating individual constraints for each variable, the LLM is tasked with constructing logical formulas that combine multiple constraints using logical connectives such as AND, OR, NOT, and implications (IF-THEN statements). The LLM analyzes the user prompt and the LLM-generated answer to identify the relevant information and relationships between the variables.

The LLM can be fine-tuned on a dataset that includes examples of user prompts, LLM-generated answers, and their corresponding logical formulas over constraints. During the fine-tuning process, the LLM learns to identify the relevant information from the input data and construct meaningful logical formulas that accurately capture the relationships between the variables.

To generate the logical formulas, the LLM may employ techniques such as pattern matching, semantic parsing, and logical reasoning. It can recognize keywords, phrases, and sentence structures that indicate conditional statements, comparisons, and mathematical operations. The LLM can then map these linguistic patterns to the corresponding logical connectives and constraint expressions.

By constructing logical formulas over constraints, the LLM provides a more comprehensive and precise representation of the input and output variable constraints. These formulas can capture complex relationships, conditionals, and dependencies that may not be easily expressed through individual constraints alone.

The resulting logical formulas can be postprocessed and validated to ensure their correctness and consistency. They can then be used in conjunction with the selected set of formal logic constraints to perform a more accurate and nuanced satisfiability check.

By incorporating the construction of logical formulas over constraints into step 225 of the sub-method, the generative AI assistant service 118 can leverage the fine-tuned LLM to derive a more expressive and precise representation of the constraints. This enhances the overall accuracy and effectiveness of the constraint determination process, leading to a more reliable validation of the LLM-generated answer. Fine-tuning steps may occur as part of processing an input user query or at a separate training phase.

At step 230, the generated constraints are (post) processed. The generated output from the LLM is processed to extract the variable constraints. Any formatting or conversion of the constraints to match the required format for the subsequent steps of the method is performed. The generated constraints are validated to ensure they are syntactically correct and semantically meaningful.

At Step 235, the variable constraints are returned. The extracted input and output variable constraints may be stored in separate data structures (e.g., lists or dictionaries). These data structures may be returned to the main method for further processing and integration with the selected set of formal logic constraints. The returned constraints may be in a logical/pseudo-code form as described with regard to Step 134 above.

By following this sub-method 200, the generative AI assistant service 118 can use an LLM to automatically determine the constraints based on the user prompt 124, LLM-generated answer, and the function signature of the corresponding programming language code. The fine-tuned LLM learns to understand the patterns and relationships between the input data and the desired constraints, enabling it to generate accurate and relevant constraints for the specific scenario.

This sub-method 200 automates the process of extracting constraints from the available information, reducing the need for manual analysis and interpretation. The generated constraints can then be used in conjunction with the selected set of formal logic constraints to perform the satisfiability check and validate the LLM-generated answer.

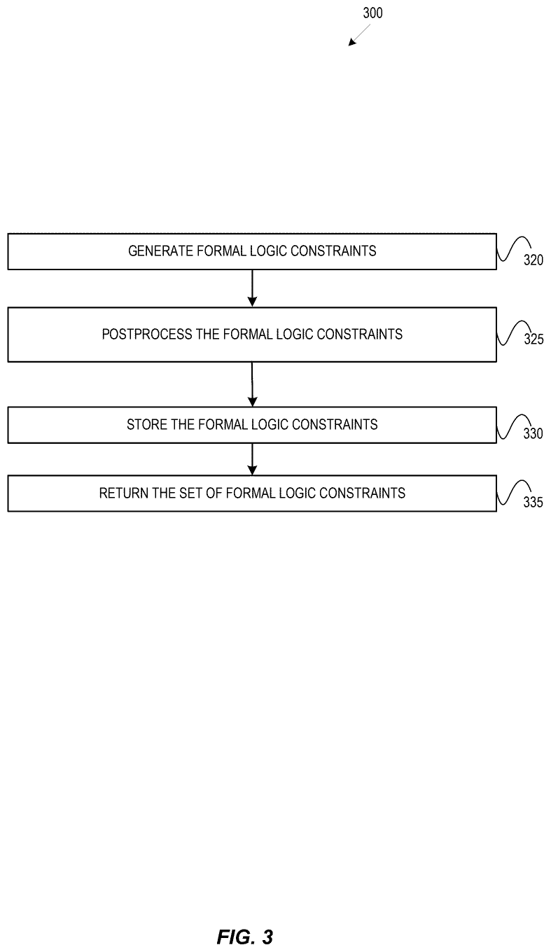

Additionally, the system may rely on other logic constraints that may not have been expressly included in/derived from the user query. For example, a user profile or other preference data may include information about a user that has been processed to a logic constraint. For example, user preference data may indicate that a user is vegetarian. This information may have been previously processed by the system (for example using steps such as those described with regard to FIG. 1A) to establish a logic constraint that represents that any meals determined for the user should be vegetarian. In another example, user preference data may indicate that a user has a mobility issue and thus any travel plans made for the user should be wheelchair accessible. This information may also have been previously processed by the system (for example, prior to receipt of a user query to be answered) to store a logic constraint indicating the need for wheelchair accommodations in any event/travel planning. Such information may not be expressly indicated by a user in each query submitted to the system. For example, a user who travels with a wheelchair may not say “wheelchair accessible” each time the user submits a user query; it may be expected for the system to track this constraint information. As another example, domain-related information may include information that can be used to determine potential variables for responding to a user query. The system may store data indicating various types of information related to the domain. For example, data for the travel domain may include hotel/accommodations, attractions, restaurants, ways to travel to a location or within a location (e.g., airport, bus, train, etc.), and other information. In an example, for a user query related to travel (e.g., “help me plan a trip to [city] . . . ”), the system may determine travel domain information corresponding to the indicated [city] (e.g., available accommodations in the [city], restaurants in the [city], etc.). Thus, implicit logic constraints, those derived from user information, domain information, etc. may be stored by the system and applied where relevant to particular user queries. Such a process is illustrated in FIG. 3.

As shown in FIG. 3, at Step 320, a set of formal logic constraints is generated for information available to the system that may be used to process user queries. This process may involve processing natural language information (for example using an LLM as shown in FIG. 1A) such as information about a user, or may involve processing other information the system may use for later processing user queries. Such information may be processed to generate logic constraints for later use. The information may be converted into formal logic constraints using a suitable logic formalism (e.g., first-order logic, Satisfiability Modulo Theories (SMT)). The generated constraints may be simplified and optimized, if possible, to improve their clarity and efficiency.

At Step 325, the formal logic constraints undergo post-processing. Post-processing may include performing any transformations or optimizations on the generated constraints, such as reducing redundancy or eliminating irrelevant constraints; ensuring that the constraints are well-formed and adhere to the syntax and semantics of the chosen logic formalism; and organizing and structuring the constraints in a way that facilitates their use in subsequent steps of the method.

At Step 330, the generated set of formal logic constraints is stored which may include associating the generated formal logic constraints with the user profile, or other identifying source or other relevant metadata; storing the constraints in a suitable format, such as a structured file or a database, for easy retrieval and processing; and maintaining any metadata or references to link the constraints back to their source.

At Step 335, the set of formal logic constraints is returned. This returning may include packaging the generated formal logic constraints into a structured format, such as a constraint object or a logical expression, and returning the set of formal logic constraints when called for to be used in processing a user query (for example in Step 430 below).

By following this sub-method 300, the system can capture and recall information that may be useful in processing a user query, even if not formally included in the query itself. The resulting formal logic constraints serve as a foundation for reasoning, validation, and analysis in subsequent steps. The operations of sub-method 300 may happen at various times, but in certain configurations may happen prior to receipt of a runtime user query, e.g. prior to receipt of query 124 illustrated in FIG. 1A.

As noted above, the system uses the user prompt to determine input (and potentially output) variable constraints on the corresponding variables of the selected formal logic constraints. Following receipt and processing of user query 124 and determination of a solution thereto, the system may perform a check of the solution to determine that it satisfies the logic constraints of both the user query and the logic constraints that may have been determined in sub-process 300.

The generative artificial intelligence (AI) assistant service 118 (or other service) in the multi-tenant provider network 102 may thus obtain two pieces of information: a user query 124 and an LLM-generated answer to that user query 124. The user query 124 and the LLM-generated answer are obtained by the generative AI assistant service 118 within the multi-tenant provider network. This ensures that the processing and generation of the answer occur within the secure and controlled environment of the provider network, using its computational resources and AI capabilities. The system may then use the formal logic constraints to check the validity of the LLM-generated answer. Such a check may potentially account for LLM hallucination, lack of domain-specific knowledge, potential failure to account for a specific (explicit or implicit) logical constraint, or the like.

The system may select a particular set of formal logic constraints from the sets of formal logic constraints generated in various operations discussed above. The purpose of this selection is to identify the specific set of constraints that are relevant for performing a satisfiability check corresponding to the constraints determined relevant to the user query 124. The selection process may involve analyzing the user query 124 and other information to determine which set of constraints is most relevant to the specific query or topic at hand.

The selected set of formal logic constraints may comprise a set of one or more input variables and a set of one or more output variables. By selecting a particular set of formal logic constraints, the system narrows down the focus to the specific logical representation that is most pertinent to validating the satisfiability. This selection helps in streamlining the validation process and ensures that the relevant constraints are used to assess correctness and consistency.

In an embodiment, the selection of the particular set of formal logic constraints is performed by the generative AI assistant service 118 itself. This means that the service has the intelligence and capability to analyze the user query 124 and the available sets of constraints to make an informed decision on which set is most appropriate for the validation task.

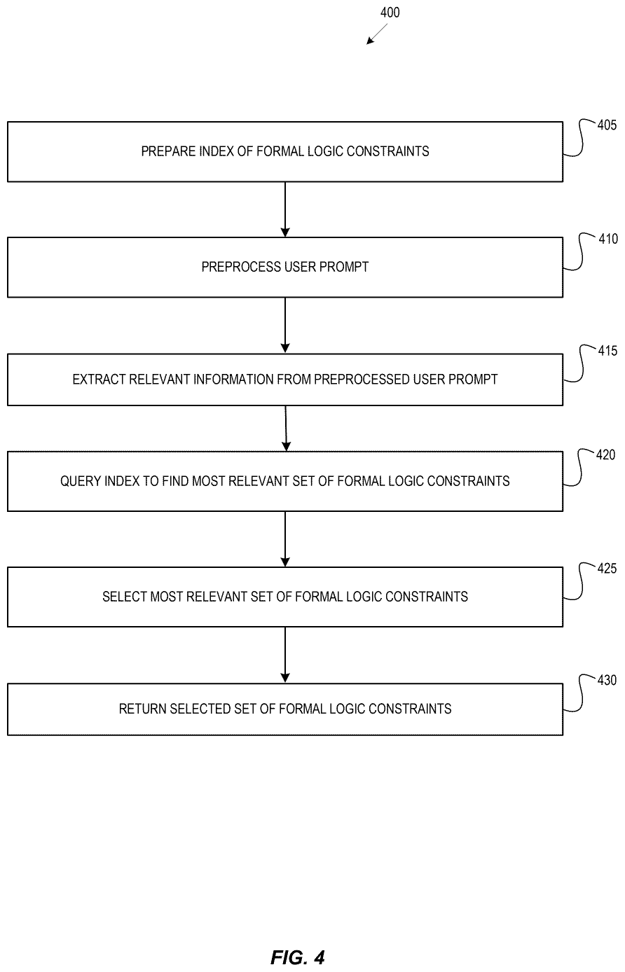

FIG. 4 is a flowchart of a sub-method 400 for selecting a particular set of formal logic constraints, of the sets of formal logic constraints, for validating the satisfiability of the representation of the user prompt, according to an embodiment. According to the sub-method 400, information extracted from the user query 124 (and potentially other information) is used to query an index to identify the most relevant set of formal logic constraints.

As an initial step 405 of the sub-method 400 (that may be performed prior to receipt of a specific user query to be processed), the index of the sets of formal logic constraints is prepared. This includes creating an index or database that stores or references the sets of formal logic constraints generated in sub-process 300. Each set of formal logic constraints may be associated with relevant metadata, such as the user profile, domain-specific keywords, or the like.

The index may be keyword based or embedding based. If using keyword-based matching, relevant keywords or phrases from each set of formal logic constraints, the user profile, or domain-specific keywords, are extracted or obtained. The keywords are stored in the index (e.g., an inverted keyword index) along with the associated sets of formal logic constraints. If used embedding-based matching, then vector embeddings may be generated from each set of formal logic constraints, the user profile, or domain-specific keywords, using machine learning-based natural language processing techniques like word embeddings or sentence embeddings. The generated vector embeddings are stored in the index (e.g., a nearest neighbors' index).

At step 410, the user prompt 124 obtained at Step 132 of the method of FIG. 1A is preprocessed. This preprocessing may include tokenizing the user prompt into individual words or phrases; performing text normalization techniques, such as lowercasing, removing punctuation, and handling special characters; removing stop words (e.g., common words like “the,” “a,” “an”, etc.) from the user query 124; or applying stemming or lemmatization to reduce words to their base or dictionary form.

At step 415, relevant information is extracted from the preprocessed user prompt. This may include identifying and extracting key phrases, named entities, or relevant terms from the user query 124. Weights or importance scores may be assigned to the extracted information based on their relevance to the domain or context. A structured representation (e.g., a dictionary or vector) of the extracted information may be created along with their corresponding weights.

At step 420, the index is queried to find the most relevant set of formal logic constraints. If using keyword-based matching, the extracted information from the user prompt is used as query keywords. The index is searched to find the sets of formal logic constraints that have the highest overlap or similarity with the query keywords. The sets of formal logic constraints are ranked based on their relevance scores or the number of matching keywords. If using embedding-based matching, a vector embedding is generated for the information extracted from the user prompt. The generated embedding is compared with the stored embeddings of the sets of formal logic constraints using similarity measures like cosine similarity or Euclidean distance. The sets of formal logic constraints are ranked based on their similarity scores to the query embedding.

At step 425, the most relevant set of formal logic constraints is selected. The top-ranked set of formal logic constraints may be selected based on the relevance or similarity scores obtained from the index query. If multiple sets of formal logic constraints have similar high scores, additional criteria may be considered like the domain relevance, the complexity of the constraints, or the coverage of the input and output variables. Finally, the selected set of formal logic constraints is retrieved from the index. In one embodiment, logic constraints that are determined from the user query 124 (for example those determined in steps 134-138) may be automatically selected along with other potentially relevant logic constraints.

At step 430, the selected set of formal logic constraints is returned to the next step of the method for further processing and validation.

By following this sub-method 400, the generative AI assistant service 118 can effectively utilize the information extracted from the user query 124 to query an index and identify the most relevant set of formal logic constraints. The index can be designed to support either keyword-based or embedding-based matching, depending on the specific requirements and characteristics of the formal logic constraints and the domain.

The selected set of formal logic constraints may be the most suitable for validating the satisfiability based on the relevance and similarity to the user query 124 and answer. This sub-method 400 helps in efficiently narrowing down the available sets of formal logic constraints to the most pertinent one, enabling accurate and targeted validation of the logical representation of the user query 124.

Once the most relevant logic constraints are selected, the system may perform a satisfiability of the constraints with respect to the representation of the user query 124 to determine if it is possible to find a solution of the variables that will satisfy the representation or if further processing is necessary to determine a satisfiable representation.

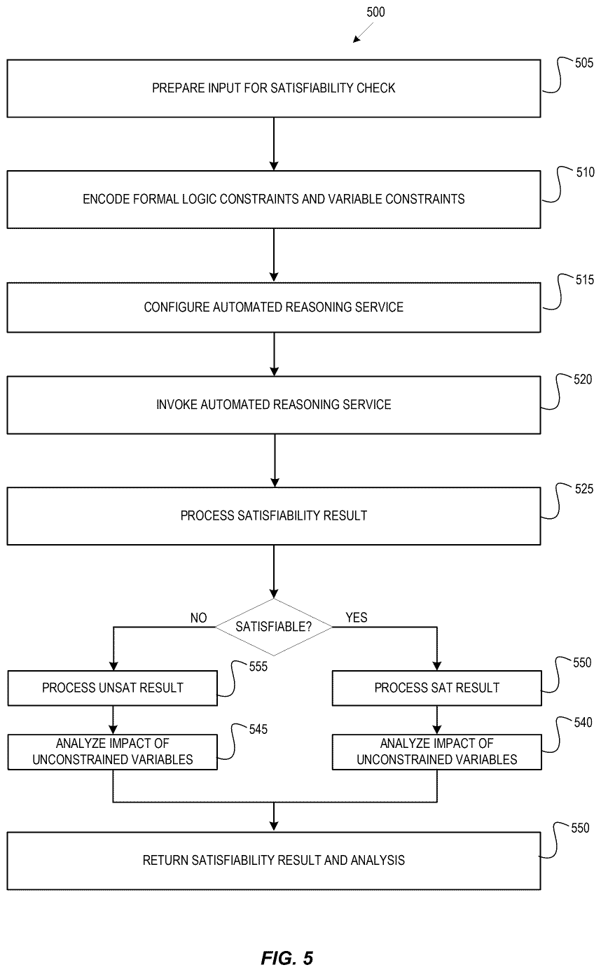

The formalized text with indicators of logical operands, variables, and other descriptive language of the constraints as generated by the LLM in step 134/sub-process 200/400 are then passed to the SMT solver 180 (shown in FIG. 1A), which includes a component to perform SAT operations on the logical atoms of the pseudo-code. Referring to FIG. 1A, the SAT component may perform (136) an SAT analysis over the logical atoms of the user query. The SAT analysis is described below in more detail in relation to sub-method 500 and FIG. 5.

During the satisfiability check, the automated reasoning service 120 takes the particular set of formal logic constraints representing the user query as determined by the LLM (and any additional logical constraints selected above as relevant to the user query) and the determined input variable constraints as input. It then uses advanced reasoning techniques, such as constraint solving or theorem proving, to explore the space of possible variable assignments and evaluate the satisfiability of the constraints. The automated reasoning service 120 systematically considers different combinations of values for the variables, taking into account the specified constraints. The automated reasoning service 120 may determine whether these combinations satisfy the logical relationships, conditions, and dependencies encoded in the formal logic constraints.

If the automated reasoning service 120 finds a set of variable assignments that satisfies all the constraints, it means that the representation of the user query is consistent with the formal logic constraints. In other words, there exists at least one scenario or interpretation where an answer to the user query may be found that aligns with the logical requirements and conditions specified in the constraints.

On the other hand, if the automated reasoning service 120 determines that no set of variable assignments can satisfy the constraints, it indicates that the LLM-generated representation of the user query is inconsistent or contradictory to the formal logic constraints. This suggests that the representation may be incorrect or incomplete.

The satisfiability check performed by the automated reasoning service 120 may be a computationally intensive task, especially when dealing with complex constraints and a large number of variables. The service may employ various optimization techniques, heuristics, or problem-solving strategies to efficiently explore the search space and determine satisfiability.

The automated reasoning service 120 encapsulates the logic and algorithms to perform the satisfiability check, abstracting away the complexity from the other components of the system. It provides a specialized capability within the multi-tenant provider network 102 to reason about the formal logic constraints and assess the consistency of the LLM-generated representation of the user query.

FIG. 5 is a flowchart of a sub-method 500 for performing a satisfiability check of the particular set of formal logic constraints under the set of one or more input variable constraints, according to an embodiment.

At Step 505, the input for the satisfiability check is prepared. The particular set of formal logic constraints selected in sub-method 400 are retrieved from or provided by the generative AI assistant service 118. The set of one or more input variable constraints are also retrieved or provided. The constrained and unconstrained input (and potentially output) variables based on the retrieved constraints are identified.

At Step 510, the formal logic constraints and variable constraints are encoded. The formal logic constraints are converted into a suitable format supported by the automated reasoning service 120 (e.g., a format such as Satisfiability Modulo Theories Library (SMT-LIB), Thousands of Problems for Theorem Provers (TPTP)). The variable constraints are encoded into the same format, representing the restrictions on the variable values. Unconstrained variables may be represented as free variables without any specific constraints.

At Step 515, an automated reasoning service 120 is configured. The automated reasoning service 120 is set up with the parameters and options (e.g., timeout, resource limits, solving strategies). The desired output format for the satisfiability result (e.g., SAT/UNSAT, model, proof) is specified.

At Step 520, the automated reasoning service 120 invoked. The encoded formal logic constraints and variable constraints are passed to the automated reasoning service 120. The satisfiability check computation is triggered.

At Step 525, the satisfiability result is processed. The output from the automated reasoning service 120 is retrieved and the satisfiability result is interpreted.

If the result is SAT (satisfiable), then the satisfying assignment (model) for the constrained and unconstrained variables is extracted. It is verified that the satisfying assignment adheres to the variable constraints. The satisfying assignment is stored for further analysis or use in generating the response to the user prompt.

If the result is UNSAT (unsatisfiable), then it is concluded that no variable assignment exists that satisfies the formal logic constraints under the given variable constraints. Optionally, any unsatisfiable core or proof provided by the automated reasoning service 120 can be retrieved/obtained to identify the conflicting constraints. The unsatisfiability information is stored for use in generating the response to the user prompt, indicating the inconsistency the formal logic constraints and representation of the user query. Any errors or exceptions encountered during the satisfiability check process are handled.

At Step 540, If there are unconstrained variables and the result is SAT, then the impact of unconstrained variables is analyzed. The satisfying assignment is examined to identify the values assigned to the unconstrained variables. The implications of the unconstrained variables on the overall consistency and validity of the logical representation of the user query are considered. It is determined if additional information or constraints are needed to refine the validation process.

At Step 545, if there are unconstrained variables and the result is UNSAT, then it is assessed whether the unsatisfiability is due to the constrained variables alone or if the unconstrained variables contribute to the inconsistency. The potential impact of the unconstrained variables on the validity is considered.

At Step 550, the satisfiability result and analysis are returned. A structured representation of the satisfiability result is prepared, including the SAT/UNSAT status, satisfying assignment (if applicable), and any additional analysis or insights. The satisfiability result and analysis are returned to the generative AI assistant service 118 for further processing and integration into the response generation step.

In an embodiment of the sub-method 500, when the satisfiability check yields an UNSAT (unsatisfiable) result, corrections to the representation of the user query can be generated to make the representation satisfiable under the given formal logic constraints and variable constraints. This process involves extracting the UNSAT core, using an LLM to explain the UNSAT core, and generating a minimal correction set sufficient to make the representation of the user query satisfiable.

The UNSAT core represents a minimal subset of the formal logic constraints and variable constraints that are responsible for the unsatisfiability. By extracting the UNSAT core, the automated reasoning service 120 can identify the specific constraints that are causing the inconsistency in the representation of the user query.

Once the UNSAT core is obtained, an LLM can be employed to analyze and explain the UNSAT core in natural language. The LLM can be fine-tuned or trained on a dataset of UNSAT cores and their corresponding explanations. Given the UNSAT core, the LLM generates a human-readable explanation that highlights the conflicting constraints and provides insights into why the representation of the user query is unsatisfiable.

Furthermore, the LLM can be prompted to generate a minimal correction set, which represents a set of modifications to the representation of the user query that may make it satisfiable under the formal logic constraints and variable constraints. The LLM can be trained on examples of unsatisfiable answers, their corresponding UNSAT cores, and the corrected answers that resolve the unsatisfiability.

By generating corrections to the representation of the user query based on the UNSAT core and the LLM's explanations and proposed modifications, the generative AI assistant service 118 can provide more accurate and consistent responses to the user query 124. The corrections ensure that the final response adheres to the formal logic constraints and variable constraints derived from the user query 124.

By following this sub-method 500, the automated reasoning service 120 can perform the satisfiability check on the formal logic constraints, considering the constrained and unconstrained variables. The sub-method 500 handles both satisfiable and unsatisfiable cases, providing insights into the consistency and validity of the representation of the user query. The analysis of unconstrained variables helps identify potential ambiguities or areas where additional information may be required to refine the validation process.

The satisfiability check validates the representation of the user query against the selected formal logic constraints. It determines whether the representation of the user query is consistent with the logical requirements and conditions specified in the constraints. After the automated reasoning service 120 completes the satisfiability check, it produces a result that indicates whether the formal logic constraints are satisfiable or unsatisfiable under the given variable constraints. This result is then communicated back to the generative AI assistant service 118

If the satisfiability check result is SAT (satisfiable), it means that there exists at least one set of variable assignments that satisfies all the constraints. In other words, the representation of the user query is consistent with the formal logic constraints, and there is a valid scenario or interpretation that supports an answer to the user query. The generative AI assistant service 118 may also receive additional information, such as the satisfying assignment(s) or model(s), which provide specific values for the input and output variables that make the constraints true.

On the other hand, if the satisfiability check result is UNSAT (unsatisfiable), it indicates that no variable assignment can satisfy the constraints. This means that the representation of the user query is inconsistent or contradictory to the formal logic constraints derived from the procedural text chunks. The generative AI assistant service 118 may receive additional information, such as an unsatisfiable core or proof, which highlights the specific constraints that lead to the inconsistency.

If the satisfiability check result is SAT, the SAT (or other component) may then propose (e.g., determine, recommend, suggest, predict, etc.) a solution to the pseudo-code in terms of which logical atoms to satisfy in order to satisfy the constraint(s) output by the LLM. This proposed solution may be referred to as a model of the logical statement(s) of the pseudo-code/constraints.

A model of the logical statement(s) may be an assignment of values to variables and, in some cases, interpretations of functions and/or constants that make a given formula or logical expression TRUE. For example, in a Boolean logical expression, the model may be an assignment of TRUE or FALSE to each variable that results in the logical expression being TRUE. In a mathematical formula, the model may be an assignment of a numerical value to each variable and/or and interpretation assigned to each function and/or constant that results in the equation being true. A model is one possible way of showing that a problem is satisfiable (“SAT”). In some cases, the problems to be solved by the system may be nondeterministic polynomial-time complete, or “NP-complete.” NP-complete refers to the complexity of the problem in a computational sense. NP-complete problems are the hardest problems to solve in the NP class of problems; however, a solution to an NP problem may be verified quickly (e.g., in polynomial time) using the model. Thus, the model may be used by the system and/or the requestor to verify the result. In some cases, the system may use the model to verify the solution and record that it has done so, while discarding the model itself. In cases where the problem is found to be unsatisfiable (“UNSAT”), no model exists to verify the result. In the case of a result of UNSAT, the system may, in some implementations, produce a proof of the result (e.g., that the problem is UNSAT). Thus, the system may store a model for a problem found to be SAT, and/or a proof for a problem found to be UNSAT.

Returning again to the example above, a logical restatement of the LLM output may be:
“[X₁]” is heavy” [C₁] AND “[X₂] is light” C₂
AND “[X₁] and [X₂] do not contain red meat” C₃
AND “[X₁] and [X₂] are balanced” C₄
where the SAT component chose one option for the first variable X₁ (e.g., heavy) and thus an option for the second variable X₂ (e.g., light), and completed the logical statements based on those choices. As can be appreciated, other choices for the variables are also possible by the SAT component so long as they satisfy the overall logical constraints of the user query. In the example above, C₁ represents a first constraint (X₁ being heavy), C₂ represents a second constraint (X₂ being light), C₃ represents a third constraint (both X₁ and X₂ not containing red meat), and C₄ represents a fourth constraint (X₁ and X₂ together being balanced). This may be seen as a fill in the blanks problem with placeholders of [x_1] and [x_2] denoting variables in the constraints that have to be filled in (for example by an LLM solver). The SAT component (or other component) may thus formalize the constraints into a single logical statement:
C₁(X₁) AND C₂(X₂) AND C₃ (X₁,X₂) AND C₄ (X₁,X₂)
Thus indicating that there are four constraints, where all four constraints are to be satisfied and the first constraint depends on the second variable, the second constraint depends on the second variable, the third constraint depends on both the first variable and the second variable and the fourth constraint depends on both the first variable and the second variable. The restatement of these four constraints and their variables is shown as an output of step 138 in FIG. 1A.

To generalize, a representation of the satisfiability problem (e.g., a propositional model output by the SAT component) is presented to the LLM in the following form, after passing through the SAT solver:
C₁ (X₁ . . . X_{N}) AND . . . AND C_{M} (X₁ . . . X_{N})
where {C₁ . . . C_{M}} represent M constraints represented in natural language form containing N unknown variables {X₁ . . . X_{N}} upon which the individual constraints depend, whose positions (depending on the dependency of the respective constraint on the respective variable is indicated by placeholder Xᵢ. The system may then determine (140) a natural language representation of the logical restatement of the constraints to the LLM and send it to the LLM to process (142) and assign values to the N variables (e.g., strings) such that they satisfy the constraints. The natural language representation of the logical restatement may be determined by replacing logical indicators (e.g., “&”) with their natural language equivalents (e.g., “and”).

Returning to the example of a lunch order above, an example natural language restatement of the constraints and the variables for the example is shown as an input to step 142 in FIG. 1A. To input the constraints/variables to the LLM, they may be put into a prompt. For example, the prompt input to the LLM may be something like:
{You have been given the following input user query:
Query: “Find a balanced entree and side for lunch. If the entree is heavy the side should be light, and they should not contain red meat.”
There are two values you need to find values for:
[ENTRÉE] and
[SIDE]
The values must satisfy the following:
[ENTRÉE] is heavy
[SIDE] is light
[ENTRÉE] and [SIDE] do not contain red meat
[ENTRÉE] and [SIDE] are balanced
Output values for [ENTRÉE] and [SIDE]}

The prompt may also include other information such as the domain of the task (menu planning), the location of the user, user preferences, available grocery stores, or other information available to the system. The LLM solver may then process (142) the prompt to determine a solution, which will include values for the variables in the constraints. For example, the output of the LLM may be:
{Your lunch should be:
[ENTRÉE]=grilled salmon
[SIDE]=steamed vegetables
Salmon is heavy in calories while steamed vegetables are light in calories. They both do not contain red meat and they are balanced.}
The output of the LLM may also include more than one answer. For example, the output of the LLM may be:
{Your lunch could be one of two choices. The first choice, your lunch should be:
[ENTRÉE]=grilled salmon
[SIDE]=steamed vegetables
Salmon is heavy in calories while steamed vegetables are light in calories. They both do not contain red meat and they are balanced.
The second choice, your lunch should be:
[ENTRÉE]=falafel
[SIDE]=salad
Falafel is heavy in calories while salad is light in calories. They both do not contain red meat and they are balanced.}

The process of SAT processing and LLM processing may involve several passes before constraints are finalized and a solution found. If the processing (142) by the LLM is unable to assign values to the variables, or if assignment of variables is not likely (144: No) the LLM may output an indication of which variable(s) it cannot determine and/or a request for new constraints and send data back to the SAT component for further processing of steps 136-142. During such processing the system may determine new constraints, new prompt text, or the like to be sent to the LLM for a new solving attempt to ultimately arrive at a solution/variable value(s). If assignment of variables is likely (144: Yes), the LLM may output value(s) for the respective value(s), for example as shown in FIG. 1A.

As can be appreciated, the operations described herein may be used to solve queries in a variety of domains, including those that traditionally have been difficult to solve with solver architectures, even those that use LLMs to assist with language processing. For example, the present operations may show significant improvement in domains such as meal planning, travel planning, calendaring, etc.

In another example, the system may be tasked with a travel planning query, such as: “Could you create a travel plan for 7 people from Ithaca to Charlotte spanning 3 days, from March 8th to Mar. 14, 2025, with a budget of $30,200?” Such a natural language query may be processed by the LLM to extract and auto-formalize the constraints. The formal statement may be processed using SAT techniques to determine a model which may be expressed in natural language form and added to a prompt to the LLM to act as a solver for the problem. Such a prompt may look like:

{You have been given the following input user query:
Query: Could you create a travel plan for 7 people from Ithaca to Charlotte
spanning 3 days, from March 8th to March 14th, 2022, with a budget of $30,200?
Information: {information about the query cities obtained and inserted into the
prompt}
Constraints: The sum of the prices for 7 people of [transportation_1],
[breakfast_1], [lunch_1], [dinner_1], [accommodation_1], [transportation_2],
[breakfast_2], [lunch_2], [dinner_2], [accommodation_2], [transportation_3],
[breakfast_3], [lunch_3], [dinner_3], [accommodation_3] does not exceed
30,200. [accommodation_1], [accommodation_2], [accommodation_3] must be
suited for 7 people.
Please complete the following:
Travel Plan:}

As shown, the variables [transportation_1], [transportation_1], and [transportation_1] represent the transportation aspects of the travel as determined by the earlier steps of the process, [breakfast_1], [lunch_1], [dinner_1], [breakfast_2], [lunch_2], [dinner_2], [breakfast_3], [lunch_3], and [dinner_3], represent the meal aspects of the travel as determined by the earlier steps of the process, and [accommodation_1], [accommodation_2], and [accommodation_3] represent the accommodation aspects of the travel as determined by the earlier steps of the process.

Once the LLM determines an output of an example travel plan, the system may refine/check the plan, for example, by creating a new input to the LLM with a validation query such as “do you think that this {constraint} is satisfied? If not, modify the travel plan to satisfy the {constraint}.” This may be performed constraint by constraint. Such refinement/checking may improve the adherence of the generated plan with respect to the constraints, even mathematical constraints. Such refinement/checking may occur several times until the system is satisfied with the solution.

Once the system has confirmed the accuracy of the solution suggested by the LLM in step 142, the system may generate a response to the user/client 104.

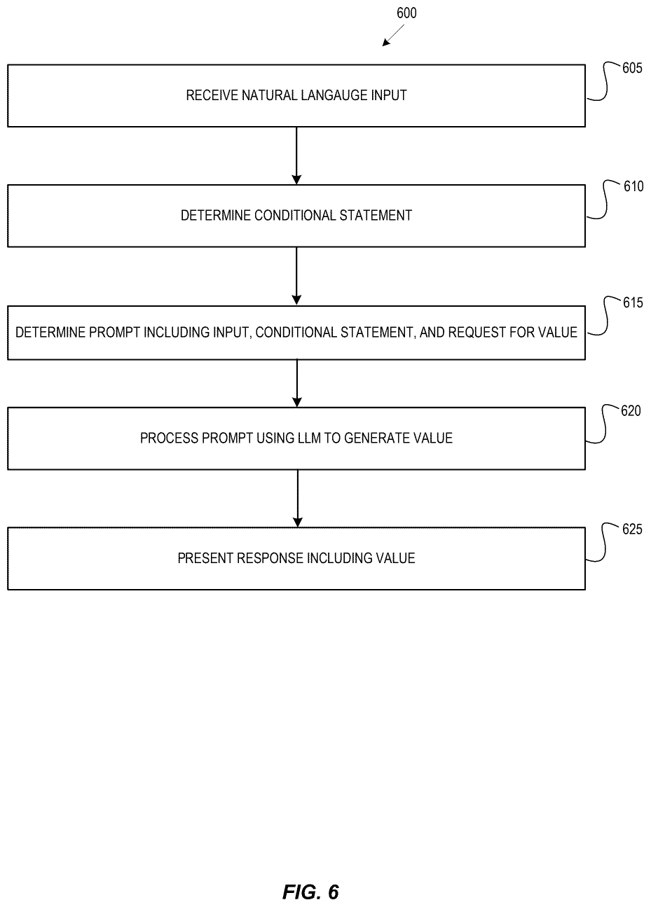

FIG. 6 is a flowchart of a sub-method 600 for using a language model as a theory solver, according to an embodiment. As shown, at Step 605 the system may receive a natural language input (e.g., user query 124) where the natural language input requests a first output based on a first constraint. At Step 610 the system may determine a conditional statement corresponding to the first constraint and corresponding to a first variable associated with the first constraint. This may be performed, for example by processing the query using a language model to determine a representation of the constraint, for example as described above in reference to step 134 and other examples. The system may determine a representation of the input and constraint and determine that the representation is satisfiable using at least one value for the variable, as described above. At Step 615 the system may determine a prompt including the natural language input, the conditional statement, and a request to determine a value for the first variable that may satisfy the conditional statement, as described above. At Step 620 the system may process the prompt using the language model to generate a language model output that includes a first value for the first value, as described above. At Step 625 the system may present an output that includes the first value in response to the natural language input. This may include presenting the output on a display, outputting audio including the first value (e.g., a synthesized speech response), or the like.

In generating the response, the generative AI assistant service 118 may employ various natural language generation techniques, such as template-based generation, rule-based generation, or LLMs, to construct a coherent and user-friendly response. The service may also consider the context of the user prompt, the domain-specific knowledge, and the desired tone and style of the response.

By generating a response based on a confirmation of the LLM generated response, the generative AI assistant service 118 fulfills its role of providing helpful and informative assistance to the user.

The response is sent back to the client 104 who originally submitted the user prompt 124. The response is transmitted through the same intermediate network 106 that is used to receive the user prompt 124, ensuring a seamless and secure communication channel between the user and the AI assistant service 118.

The intermediate network 106 acts as a bridge between the client 104 and the multi-tenant provider network 102, facilitating the exchange of information between the two entities. It handles the network protocols, security measures, and data formatting to ensure that the response reaches the client in a reliable and efficient manner.

Once the response is received by the client 104, it can be presented to the user through the appropriate interface or application. The user can then review the response and assess whether it satisfies their original query or prompts further questions or actions.

Several steps in the method and techniques described herein involve prompting an LLM and can potentially benefit from the use of retrieval augmented generation to improve the LLM's response generation process.

Retrieval augmented generation (RAG) is a technique that enhances the performance of LLMs by providing them with relevant information retrieved from external knowledge sources. In the context of the method of FIG. 1A, when the generative AI assistant service 118 obtains the user prompt 124 and generates an LLM-generated answer, it can utilize retrieval augmented generation to improve the quality and accuracy of the generated response.

The process can work as follows: upon receiving the user prompt 124, the generative AI assistant service 118 can employ an information retrieval system to search for relevant information that may be useful in determining a response to the user query 124. For example, if the system determines the query is travel related, the RAG system may retrieve information related to travel, if the system determines the query is food related, the RAG system may retrieve information related to food, etc.

The retrieval/RAG system can use various techniques such as keyword matching, semantic similarity, or machine learning-based relevance scoring to identify the most pertinent information related to the user query 124.

The retrieved information can then be used to augment the input to the LLM during the response generation process, such as any of the various steps described above that invoke the LLM. For example, the retrieved information can be concatenated with the user prompt 124, providing the LLM with additional context and background knowledge relevant to the prompt 124. This augmented input can help the LLM generate more informed and accurate responses by leveraging the retrieved information.

Furthermore, retrieval augmented generation can be useful in step of selecting a particular set of formal logic constraints for validating the LLM-generated logical representation of the user query. By retrieving potentially relevant knowledge, the generative AI assistant service 118 can have access to a broader range of constraints that are potentially relevant to the user prompt 124. This can facilitate the selection and application of the most appropriate set of formal logic constraints.

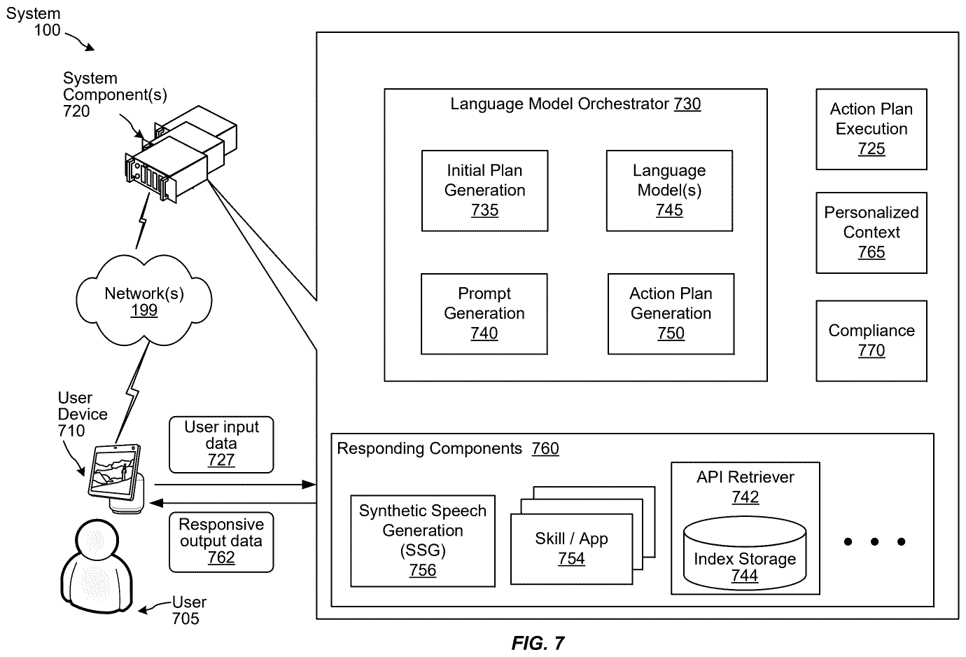

FIG. 7 illustrates further example components included in the system 100 configured to use a language-model based approach to determine an action to be performed in response to a user input and determine a response to be presented to a user 705. As shown in FIG. 7, the system 100 may include a user device 710, local to the user 705, in communication with one or more system component(s) 720 via a network(s) 199. The network(s) 199 may include the Internet and/or any other wide- or local-area network, and may include wired, wireless, and/or cellular network hardware.

In some embodiments, the system component(s) 720 may include various components that may support processing by a language model, such as a language model orchestrator component 730. In example embodiments, the language model orchestrator component 730 may include an initial plan generation component 735, a prompt generation component 740, at least one language model 745, and an action plan generation component 750. The system component(s) 720 may further include an action plan execution component 725 configured to facilitate/cause performance of actions that may be determined by the language model 745. The system component(s) 720 may further include one or more responding components 760 that may perform the actions. The language model 745 and/or other components may be part of an automated reasoning service 120, generative AI assistant service 118, SMT solver 180, or other service/system described herein.

The responding components 760 may be configured to perform an action related to a user input, including, but not limited to retrieving information potentially relevant for determining a response to the user input (e.g., data from a knowledge base, Internet search, database, an application, etc.; context related to the interaction; relevant exemplars for a prompt to the language model; relevant application programming interfaces (APIs); etc.), operating a user device (e.g., a smart home device such as a TV, lights, a kitchen appliance, etc.), determining a synthesized speech output, or other actions described herein. As shown in FIG. 7, the responding components 760 may include an API retriever component 742 (further described below), a synthesized speech generation (SSG) component 756, one or more skill/app components 754 and other components described herein.

APIs are a way for one program/component to interact with another. API calls are a mechanism by which the program/component interact. An API call, or API command, is a message sent to a system component asking an API to perform an action, provide a service or information, or the like. An API call may be formatted for the particular API and may include a particular command, optionally using particular arguments and argument values. API calls may be used for a variety of purposes, such as controlling other devices (e.g., an API call of turn_on_device (device=“indoor light 1”) corresponds to a command for a component to turn on a device associated with the identifier “indoor light 1”), obtaining information from other components (e.g., an API call of InfoQA.question (“Who is the president of USA?”) corresponds to a command for a component to find and provide an answer to the indicated question), and performing other actions (e.g., generating synthesized speech, searching data sources, etc.). The system 100 may interact with the responding components 760 via API calls.

The language model orchestrator component 730 may be configured to orchestrate processing by the language model 745. In some embodiments, the language model 745 may be configured to perform one or more stages of processing, which may be referred to as a task generation stage, an action (or directive) generation stage, and a response generation stage.

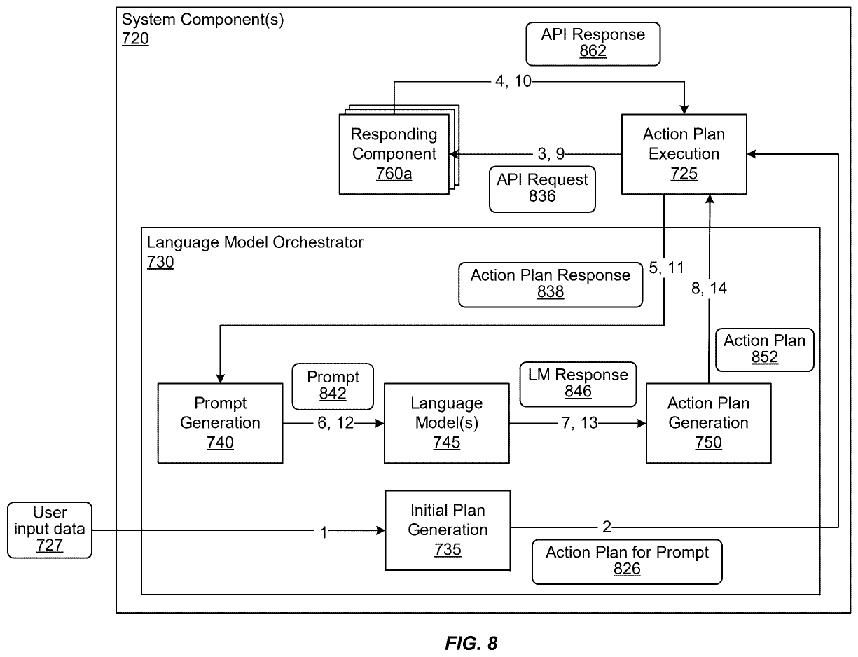

The processing stages may be performed in a particular order. For example, during a first stage of processing, the language model 745 may be tasked with performing task generation to generate a list of tasks to be performed in order to respond to a user input. During a second stage of processing, based on the list of tasks, the language model 745 may be tasked with performing action generation to generate action requests (or directives) for a responding component(s) 760 to perform an action(s) related to the tasks/user input. During a third stage of processing, based on information received from the responding component(s) 760, the language model 745 may be tasked with generating a response to the user input and/or causing a component(s) of the system 100 to perform further action(s). Further details are described herein in relation to FIG. 8.

In some cases, a subset of the stages may be performed. For some user inputs, the language model 745 may only perform the task generation stage and the response generation stage, where a response to a user input is generated by the language model 745 using parametric knowledge. For example, for a user input “What kind of fruit is lemon?”, the language model 745 may determine that the task is to answer the user's question and may generate a response “Lemon is a citrus fruit that grows on tress” based on the model's parameter knowledge learned during configuration/training operations. In such examples, the language model 745 may not determine an action that is to be performed using a system component, such as sending a request for information to a knowledge base (e.g., the language model 745 may respond without using external knowledge).

In some embodiments, the system may use Retrieval-Augmented Generation (RAG) techniques to inform processing of a language model. RAG techniques may involve referencing an authoritative knowledge base or other type of data source outside of the model's training data sources before generating a response by the model. RAG techniques may extend the already powerful capabilities of language models to specific domains, an organization's internal knowledge base, etc., without the need to retrain the model. In some embodiments, information (e.g., relevant facts, up-to-date information, current/trending topics, etc.) from one or more components (e.g., responding component(s) 760) may be provided to the language model 745 and the model may generate a output based on the received information.

In some embodiments, the language model orchestrator component 730 may be configured to orchestrate processing by multiple different language models, where an individual language model may perform one (or more) of the processing stages described above. For example, a first language model may perform task generation, a second language model may perform action generation, and a third language model may perform response generation. In some embodiments, the language models may be different types of models, for example, a first language model may be a text-to-text generative model, a second language model may be a multi-modal generative model, a third language model may be a text-to-speech generative model, etc. In some embodiments, the language models may be different sizes (e.g., number of parameters), may have different processing capabilities, etc.

Some embodiments may enable use of other components, such as plugins, with the language model 745, where the plugins may add functionality and features to the language model capabilities. For example, the plugins may be used to perform mathematical calculations (e.g., a calculator plugin), statistical analysis (e.g., a statistics plugin), natural language translation, speech generation, etc. For further example, the plugins may additionally, or alternatively, be used to perform an action responsive to a user input based on the response generated by the language model. As a further example, the plugins may cause the language model to process and output according to an enabled plugin, which may result in a different response, reasoning, processing, etc. from the language model than when the plugin is not enabled. In some cases, a user or a system may enable a plugin(s) for use with the language model.

The system component(s) 720 may include other processing components configured to process user inputs and other type of inputs (e.g., sensor data, audio data, data indicative of an event occurring, etc.) received via the user device 710. In example embodiments, the system component(s) 720 may process spoken inputs using ASR processing. The system component(s) 720 may also be configured to process non-spoken inputs, such as gestures, textual inputs, selection of GUI elements, selection of device buttons, etc. The system component(s) 720 may also include other components to understand an input, determine an action to be performed in response to receiving the input, generate an output responsive to the input, and the like. Such other components may perform natural language processing, SSG processing, etc..

As shown in FIG. 7, the system component(s) 720 may receive user input data 727 (e.g., user query 124), which may be provided to the language model orchestrator component 730 (as shown in FIG. 8). In some instances, the user input data 727 may include one or more types of data, such as text (e.g., a text or tokenized representation of a user input), audio, image, video, etc. Such data may be encoded/embedded data that represent the underlying type of data (e.g., text, audio, image, etc.). For example, the user input data 727 may include text (or tokenized) data when the user input is a natural language user input. In some embodiments, an ASR component of the system 100 may receive audio data representing a spoken natural language user input from the user 705. The ASR component may perform ASR processing on the audio data to determine ASR data representing the spoken user input, which may correspond to a transcript of the user input, the ASR component may determine ASR data that includes an ASR N-best list including multiple ASR hypotheses and corresponding confidence scores representing what the user may have said. The ASR hypotheses may include text data, token data, ASR confidence score, etc. as representing the input utterance. The confidence score of each ASR hypothesis may indicate the ASR component's level of confidence that the corresponding hypothesis represents what the user said. The ASR component may also determine token scores corresponding to each token/word of the ASR hypothesis, where the token score indicates the ASR component's level of confidence that the respective token/word was spoken by the user. The token scores may be identified as an entity score when the corresponding token relates to an entity. In some instances, the user input data 727 may include a top scoring ASR hypothesis of the ASR data. As an even further example, in some embodiments, the user input may correspond to an actuation of a physical button, data representing selection of a button displayed on a graphical user interface (GUI), image data of a gesture user input, combination of different types of user inputs (e.g., gesture and button actuation), etc. In such embodiments, the system 100 may include one or more components configured to process such user inputs to generate the text or tokenized representation of the user input (e.g., the user input data 727). As a further example, the user input data 727 may include image data representing information being displayed at the user device 710 (e.g., on-screen context data) when the user 705 provides the user input or at substantially the same time as the user 705 provides the user input. As yet a further example, the user input data 727 may include audio data representing audio signals (e.g., background noise, audio from other devices such as TV, appliances, etc.) occurring in the environment of the user 705 that can be captured by the user device 710 (e.g., audio environment context). As yet a further example, the user input data 727 may include image data representing one or more objects in the environment of the user 705 (e.g., visual environment context). As yet a further example, the system may receive image data including text (and other data), and the user input data 727 may include text determined from the image data using optical character recognition or other techniques.

In some embodiments, the system component(s) 720 may receive input data that may not be provided directly/explicitly by a user. Such other type of input data may be processed in a similar manner as the user input data 727 as described herein. Such other type of input data may be received in response to detection of an event. Example events include change in a device state (e.g., front door opening, garage door closing, TV turned off, thermostat detecting a particular temperature, etc.), occurrence of an acoustic event (e.g., baby crying, appliance beeping, glass breaking, etc.), presence of a user (e.g., a user approaching the user device 710, a user entering the home, etc.), occurrence of an event indicated by a user (e.g., a reminder/notification requested by the user, sporting event score change, start of a TV program, calendar event, etc.), and others. In some embodiments, the system 100 may process the input data and generate a response/output. For example, the input data may be received in response to detection of a user generally or a particular user, an expiration of a timer, a time of day, detection of a change in the weather, a device state change, etc. In some embodiments, the input data may include data corresponding to the event, such as sensor data (e.g., image data, audio data, proximity sensor data, short-range wireless signal data, etc.), a description associated with the timer, the time of day, a description of the change in weather, an indication of the device state that changed, etc. The system 100 may include one or more components configured to process the input data to generate a natural language representation of the input data. The system 100, for example, the language model orchestrator component 730 may process the input data and may cause performance of an action. For example, in response to detecting a garage door opening, the system 100 may cause garage lights to turn on, living room lights to turn on, etc. As another example, in response to detecting an oven beeping, the system 100 may cause a user device 710 (e.g., a smartphone, a smart speaker, etc.) to present an alert to the user. The language model orchestrator component 730 may process the input data to generate tasks (e.g., an action plan) that may cause the foregoing example actions to be performed.

FIG. 8 illustrates example processing of the user input data 727 by the system component(s) 720 using the language model 745. Although the figure and discussion of the present disclosure illustrate certain components and steps in a particular order, the components may be implemented in a different manner (as well as certain components removed or added) and the steps described may be performed in a different order (as well as certain steps removed or added) without departing from the present disclosure.

In some embodiments, the language model 745 may perform iterative processing (e.g., multiple processing cycles, multiple processing stages, etc.) with respect to individual user input data 727. Such iterative processing is illustrated and described herein with respect to FIG. 8. For example, in a first iteration of processing the language model 745 may receive a first prompt from the prompt generation component 740, in response to which the language model 745 may determine one or more tasks to be performed with respect to the user input data 727, then at least one of the determined task(s) may be performed via the action plan execution component 725, the results of the performed task(s) may be provided to the language model 745 via a second prompt, in response to which the language model 745 may determine further tasks to be performed or may determine that a (final) response to the user input is determined.

The initial plan generation component 735 may be configured to determine various information relevant to processing of the user input data 727 by the language model orchestrator component 730. The initial plan generation component 735 may generate an action plan (e.g., action plan for prompt data 826) representing one or more tasks/actions to be performed to determine the various relevant information. The relevant information may be included in a prompt to the language model 745. The initial plan generation component 735 may receive (step 1) the user input data 727 representing a user input from the user 705. Based on the user input data 727, the initial plan generation component 735 may determine information relevant for processing the user input data 727 and may output (step 2) the action plan for prompt data 826. The action plan for prompt data 826 may include one or more tasks to be performed to retrieve the relevant information. The tasks may be represented as action descriptions, API requests/calls, API descriptions, requests to a component(s) (e.g., the responding components 760), and the like. Examples tasks that may be included in the action plan for prompt data 826 may relate to obtaining certain information like context data, user profile data, user preferences, available/relevant exemplars, available/relevant APIs, etc.

In example embodiments, the initial plan generation component 735 may determine one or more types of context data relevant for the user input data 727. Types of context data may include user context (e.g., user location, user profile identifier, user demographics, user profile data, user preferences, personalized catalogs, enabled skills/applications, etc.), device context (e.g., device type, device identifier, device location (e.g., living room, kitchen, office, etc.), device capabilities, device state, etc.), environmental context (e.g., time/date the past user input was received/processed, device that received the user input, device that responded to the user input, objects proximate to the device/user, background audio/noises, state/status of device(s) in the user's environment (e.g., TV is on, thermostat temperature, etc.), dialog context (e.g., prior user inputs of a dialog, prior system responses of the dialog, dialog topic, actions performed during the dialog, etc.), and the like. As an example, if the user input data 727 corresponds to operation of a device (e.g., the user input corresponds to a smart home domain), the initial plan generation component 735 may determine that device context information, in particular device states for the devices associated with the user/user profile of the user 705, may be relevant information. As another example, if the user input data 727 corresponds to output of media, such as music, movies, TV shows, etc., the initial plan generation component 735 may determine that user context information, in particular user preference for media genre associated with the user/user profile of the user 705, may be relevant information.

Based on the type of context data determined to be relevant, the initial plan generation component 735 may output the action plan for prompt data 826 to include a request for the type(s) of context data. For example, if device context is relevant information, then the action plan for prompt data 826 may include an API call/description corresponding to a component (e.g., a device state component, a smart home component, a user profile storage, etc.) capable of providing device information. As another example, if user context is relevant information, then the action plan for prompt data 826 may include an API call/description corresponding to a component (e.g., a user profile storage, a personalized context component, etc.) capable of providing user information.

In some embodiments, the initial plan generation component 735 may determine one or more components or types of components that may be relevant for processing the user input data 727. As an example, if the user input data 727 corresponds to operation of a device (e.g., the user input corresponds to a smart home domain), the initial plan generation component 735 may determine that components (e.g., APIs) corresponding to device operation or smart home domain may be relevant, and the initial plan generation component 735 may output the action plan for prompt data 826 to include device operation components or smart home domain components. As another example, if the user input data 727 corresponds to output of media, the initial plan generation component 735 may determine components corresponding to media output or music domain may be relevant, and the initial plan generation component 735 may output the action plan for prompt data 826 to include media output components or music domain components.

In some embodiments, the initial plan generation component 735 may determine a query to retrieve exemplars and/or APIs relevant for processing the user input data 727 using the language model 745. As used herein, an exemplar refers to information that may be included in a prompt to a language model that provides an example of how the language model is to process or respond, including, among other things, what actions the language model can request performance of. A prompt may include more than one exemplar. Few shot learning or in-context learning by the language model is enabled by including the exemplars in the prompt. The query (or request) to retrieve relevant exemplars and/or APIs may be included in the action plan for prompt data 826. The query (or an API request based on the query) may be processed by the responding component 760 (e.g., an exemplar retriever component, the API retriever component 742, etc.). The query, in some embodiments, may include the user input data 727 or a portion or representation thereof.

The initial plan generation component 735 may employ one or more techniques to determine relevant information or to determine the tasks to obtain relevant information. Examples of such techniques include using one or more of machine learning models (e.g., classifiers), statistical models, rules engines, etc. to determine the relevant information. The initial plan generation component 735 may determine a topic/category corresponding to the user input data 727, a (semantically or lexically) similar past user input and relevant information corresponding to the similar past user input, and the like.

In example embodiments, the initial plan generation component 735 may use a language model to determine the types of information relevant for processing the user input data 727. The initial plan generation component 735 may input a prompt to the language model, for example, “What types of information is relevant for responding to the user input: [user input data 727]”, and the language model may output one or more types of context data, one or more types of components, etc. that may be relevant. In some embodiments, the initial plan generation component 735 may input a prompt to the language model 745 requesting relevant information for the user input data 727.

The action plan for prompt data 826, which includes types of relevant information for the user input data 727 or tasks to be performed to obtain the relevant information, may be processed by the action plan execution component 725 to retrieve the relevant information. The action plan execution component 725 may process the action plan for prompt data 826 to generate one or more requests to perform an action (e.g., API requests 836) for a particular responding component 760. For example, if the action plan for prompt data 826 indicates that device information/context is relevant, then the action plan execution component 725 may generate an API request 836 for a responding component 660a capable of providing the device information, where the API request 836 may include a user profile identifier associated with the user 705, a device identifier associated with the user device 710, and/or other information based on information required in the API call for the responding component 660a.

The API request 836 may be sent (step 3) to the corresponding responding component(s) 760. The responding component(s) 760 may include components that the action plan execution component 725 may communicate with via API requests or other type requests. As shown in FIG. 7, the responding component(s) 760 may include one or more skill/app components 754, the SSG component 756 (e.g., configured to convert input data to audio data representing synthesized speech), and the API retriever 742 (e.g., configured to provide APIs and corresponding information supported by the system 100). The responding component(s) 760 may also include an orchestrator component (e.g., configured to facilitate processing by other system components 720), a context source component (e.g., configured to provide user context data, device context data, environmental context data, dialog context data, personalized context data, etc.), a multimodal response component (e.g., configured to respond to a user input via outputs in more than one data form), a content moderation component (e.g., configured to moderate certain types of content such as biased content, harmful content, offensive content, etc.), a smart home devices component (e.g., configured to provide device information such as device state, device capabilities, etc.), a language model-based agent (e.g., a component that uses a language model (e.g., an LLM) or other type of generative model to provide information), an exemplar provider component (e.g., configured to respond to a query for relevant exemplars), a knowledge base component (e.g., including one or more knowledge bases or other structured data that can be searched to obtain information), an entity resolution component (e.g., configured to determine specific entities corresponding to entities represented in a user input or language model output), and the like.

In response to receiving the API request 836 (at step 3), the responding component(s) 760 may provide (step 4) an API response(s) 862 to the action plan execution component 725. At step 3, the API request(s) 836 is based on the action plan for prompt data 826, and thus, at step 4, the API response(s) 862 may include information relevant for processing the user input data 727. In examples, the API response(s) 862 may include relevant context information (e.g., device context, user context, environment context, dialog context, personalized context, etc.), relevant APIs and/or API descriptions for processing the user input data (e.g., API(s) for operating devices, API(s) for outputting media content, etc.), relevant exemplars, and other relevant information requested via the action plan for prompt data 826.

In example embodiments, the API request 836 may be sent to the API retriever component 742. In such cases, the API request 836 may include a query to retrieve relevant APIs based on the user input data 727. The API retriever component 742 may be configured to receive a search query and output one or more APIs or API data corresponding to (e.g., satisfying, matching, etc.) the search query. API data may include an API call, an API description, and other information associated with the API. In some embodiments, the API retriever component 742 may include or may be in communication with an index storage 744 (shown in FIG. 7). The index storage 744 may store various information associated with multiple APIs. Examples of information stored in the index storage 744 include: API/component descriptions (e.g., a description of one or more function that the API can be used to perform), API arguments (e.g., parameter inputs, input types, examples of input values, examples of output values, output type, etc.), identifiers for components corresponding to the API (e.g., alphanumerical component ID, component name, etc.), and other information. In some embodiments, the index storage 744 may include other information associated with the API, such as historical accuracy/defect rate, historical latency value, feedback (e.g., user satisfaction/feedback, system-based feedback), etc. The index storage 744 may also include sample user inputs corresponding to the API, where the sample user input may represent a user input for which the API can perform an action for.

The API retriever component 742 may apply one or more retrieval techniques to determine API data corresponding to the search query. For example, the API retriever component 742 may compare one or more APIs included/represented in the index storage 744 to the user input data 727 represented in the search query to determine one or more APIs (top-k list). Such comparison may involve a semantic comparison between the user input data 727 and the API data. In some embodiments, the API retriever component 742 may use a neural-based retrieval technique that may involve determining an encoded representation of the user input/search query and comparing (e.g., using cosine distance) the encoded representation(s) of the API data in the index storage 744. The relevant APIs may be included in the API response 862.

In a non-limiting example, for a user input “book a flight”, the API retriever component 742 may determine one or more API calls corresponding to booking a flight (e.g., Bookflight.location (“departing airport code”, “arrival airport code”), Bookflight.date (“departing date”), bookflight.rountrip (“departing location”, “arrival location”, “departure date”, “return date”), AirlineBookFlight (“departing airport code”, “arrival airport code”), etc.).

Some embodiments may include an exemplar provider component that may operate in a similar manner as the API retriever component 742 in terms of implementing one or more retrieval techniques to determine exemplars corresponding to (e.g., satisfying, matching, etc.) a search query based on the user input data 727. The exemplar provider component may search an index storage including various information related to multiple different exemplars. In some embodiments, the index storage may include sample user inputs associated with an exemplar, and the relevant exemplars may be retrieved based on a comparison of the sample user inputs and the user input data 727. The retrieved exemplars may be included in the API response 862.

The information from the API response(s) 862 may be included in a prompt to the language model 745. The action plan execution component 725 may determine action plan response data 838 based on the API response(s) 862. The action plan execution component 725 may combine (e.g., aggregate, summarize, de-duplicate, etc.) multiple API responses 862 to generate the action plan response data 838. In some examples, the action plan response data 838 may be the same or similar to the API response(s) 862. The action plan execution component 725 may send (step 5) the action plan response data 838 to the prompt generation component 740.

Using the action plan response data 838, the prompt generation component 740 may determine prompt 842 for the language model 745. The prompt 842 may be a natural language input (e.g., a natural language request, a natural language instruction, etc.). In some embodiments, the prompt 842 may include information in a manner that the language model 745 is trained for. The prompt generation component 740 may send (step 6) the prompt 842 to the language model 745, where the prompt 842 may include the user input data 727 (or a representation of the user input data 727) and the relevant information for processing the user input data 727. For example, the prompt 842 (at step 6) may include relevant context data, relevant APIs or API descriptions, etc. that may be included in the action plan response data 838. In some embodiments, the prompt 842 may include a request or directive for the language model 745 to respond to the user input data 727. In some embodiments, the prompt 842 may include one or more exemplars (e.g., in-context learning examples) for processing the user input data 727.

The prompt 842 may include indicators (e.g., labels, specific tokens, etc.) to identify certain information. In example embodiments, the prompt 842 may include a “User” indicator (to indicate that the following string of characters/tokens are the user input), an “Exemplar” indicator (to indicate exemplars), and so on.

In some embodiments, the prompts for the language model described herein may include a request for the language model to output a response that satisfies certain conditions. Such conditions may relate to generating a response that is unbiased (toward protected classes, such as gender, race, age, etc.), non-harmful, profanity-free, etc. For example, prompt data generated by a prompt generation component described herein may include “Please generate a polite, respectful, and safe response and one that does not violate protected class policy.”

In some embodiments, the prompt 842 may include an indication the processing stages (e.g., the task generation stage, the action generation stage, and the response generation stage) that the language model 745 is to perform. In some examples, for the task generation stage, the prompt 842 may direct the language model 745 to generate an output (e.g., tokens) representing the model's interpretation of the user input and/or one or more tasks to be performed to respond to the user input (the model output may be, for example, the user is requesting [intent of the user input], the user wants to [desired user action], need to determine [information needed to properly process the user input], etc.). For the task generation stage, the prompt 842 may also direct the language model 745 to prioritize a list of tasks to be performed, if more than one task is to be performed and select one (or more) task for the current iteration of processing.

In some examples, for the action generation stage, the prompt 842 may direct the language model 745 to generate an output (e.g. tokens) representing an action(s) (or directive(s)) and/or an API call(s) corresponding to the user input, where performance of the action(s) or execution of the API(s) can be done to retrieve information to determine a response to the user's input, perform the user requested action, retrieve information/data to perform other tasks on the task list, etc. In some examples, for the action generation stage, the prompt 842 may direct the language model 745 to process the results of the action(s)/API(s) determined by the language model 745, and to determine whether a response to the user input can be generated or whether there are further tasks to be performed from the task list.

In some examples, for the response generation stage, the prompt 842 may direct the language model 745 to generate an output (e.g., tokens) representing a response (e.g., a final response) to the user input data 727. In examples, the language model 745 may be directed to generate the response based on the results of performing the action(s)/API(s).

The prompt generation component 740 may send (step 6) the prompt 842 to the language model 745, which may process the prompt 842 to generate a language model (LM) response 846. The LM response 846 may be a natural language output generated based on the prompt 842. The LM response 846 may include text tokens. In other embodiments, where the language model 745 may be a multi-modal model, the LM response 846 may include other types of tokens, for example, audio tokens, image tokens, etc.

Based on receiving the prompt 842 at step 6, the language model 745 may generate the LM response 846 at step 7, where the instant LM response 846 may include outputs corresponding to the task generation stage and the action generation stage. The LM response 846 may include an action for determining information relevant to or responsive to the user input data 727. For example, the LM response 846 may include an action to search a knowledge base (e.g., to find a response to a user question), an action to determine information from a particular skill/app or language model-based agent (e.g., to determine current weather information, to determine a cost of an item, to book travel, etc.), an action to operate a device (e.g., turn on lights, set thermostat to a particular temperature, etc.), an action to request information from the user 705, etc.

In some embodiments, the LM response 846 may include an API or API description corresponding to the determined action. For example, the LM response 846 may include an API to operate a device or an API call(s) to output media content. The language model 745 may determine the actions and/or the API information based on the relevant APIs included in the prompt 842. The language model 745 may generate actions and/or API information that is not based on (e.g., correspond to, is similar to, etc.) the relevant APIs included in the prompt 842 (for example, the language model 745 may generate incorrect/unsupported actions and/or API information).

The LM response 846 may follow the format included in the prompt 842 or that the language model 745 is trained to follow. An example prompt 842 may be:

```
{
Please process the following user input and context data to determine at least one action or API
to execute and generate a response to the user.
First determine a task to perform (use “Task” label), then determine an API to perform the task
(use “Action” label), then process the results from the API, and then generate a response to the
user input (use “Response” label). You may determine multiple tasks to perform. You may
have to process iteratively.
User: Turn on living room TV
Available context:
  User devices: “living room TV” = [device id]
  “living room TV” device state = Off
Available APIs:
  TurnOn.device (device)
  TurnVolumeUp.device (device)
  SetTVChannel (device, input channel)
}
```

Based on processing the above example prompt 842, an example LM response 846 (at step 7) may be:

{
Task: User wants to turn on living room TV that is operation of a user device.
Action: I need an API to operate a device. TurnOn.device (device = “living room TV”)
}

The LM response 846 may be sent (step 7) to the action plan generation component 750, which may determine action plan data 852. As described herein, the language model 745 may generate tokens in sequence, as such, the language model 745 may generate portions of the LM response 846 in a tokens-by-tokens basis. In some embodiments, the LM response 846 may be processed by the action plan generation component 750 based on the language model 745 generating the tokens representing the action or corresponding to the action generation stage.

The action plan generation component 750 may process the LM response 846 to identify one or more actions/APIs generated by the language model 745. In examples, the action plan generation component 750 may parse the tokens/text included in the LM response 846 to extract tokens/text representing an action or API. In some embodiments, the action plan generation component 750 may be configured to determine one or more components (e.g., responding components 660a-n) configured to perform the identified action or API. Based on the LM response 846, the action plan generation component 750 may determine the action plan data 852, which may in turn cause performance of an action (e.g., execution of API calls) to determine a potential responses(s) to the user input. The action plan data 852 may include one or more APIs to be executed, where the APIs may be determined based on (e.g., extracted from) the LM response 846. For example, if the LM response 846 includes an action of “determine weather forecast for today” or an API call of “GetWeather.location ([city])”, then the action plan generation component 750 may determine the action plan data 852 to include an API call “GetWeather.location ([city])” and include an identifier for the responding component(s) 660a (e.g., a weather skill component). Instead of or in addition to an API call, the action plan data 852 may include a request to perform an action, an API description, etc. In some embodiments, the action plan generation component 750 may determine the responding components 760 based on user permissions, subscriptions, authorization or other use-enabling information associated with the user 705 (e.g., included in user profile data).

In some embodiments, the action plan generation component 750 may be configured to determine more than one responding component 760 to perform the action/execute the API indicated in the LM response 846. In some embodiments, the action plan generation component 750 may determine APIs corresponding to multiple responding components 760. For example, for the “GetWeather.location ([city])” API, the action plan data 852 may include an identifier for a first weather skill component, an identifier for a second weather skill component, an identifier for a search engine component, etc.

The action plan data 852 may be sent (step 8) to the action plan execution component 725. The action plan execution component 725 may identify the APIs in the action plan data 852 and generate executable API calls for the corresponding responding components 760. Based on the action plan data (received at step 8), the action plan execution component 725 may generate an additional (a second) API request (or multiple API requests) 836. The (additional/second) API request(s) 836 may be sent (step 9) to the responding component(s) 760. For example, the action plan execution component 725 may send a first API call to a first responding component 660a and a second API call to a second responding component 660b.

In some cases, the action plan data 852 may include incomplete API calls and the action plan execution component 725 may be configured to generate executable API calls (e.g., complete API calls) corresponding to the action plan data 852.

The action plan execution component 725 may generate one or more executable API calls including one or more parameters using information included in the action plan data 852 and/or various other contextual information (e.g., speaker recognition results, a user ID, user profile information (e.g., age, gender, location, language, geographic marketplace, etc.), device ID, device profile information, device state indicators, a dialog history, and/or a interaction history associated with the user and/or the device, etc.). In some embodiments, the various contextual information may be contextual information not provided to the language model orchestrator component 730. Prior to generating the executable commands, the action plan execution component 725 may modify (e.g., remove, filter, preempt, etc.) a directive included in the action plan data 852 that is determined to be in conflict with a system operating policy. The action plan execution component 725 may generate one or more additional executable commands corresponding to directives not included in the action plan data 852.

In response to receiving the API request(s) 836 (at step 9), the responding component(s) 760 may send (step 10) an (additional/second) API response(s) 862 to the action plan execution component 725. The action plan execution component 725 may determine (additional/second) action plan response data 838 based on the (additional/second) API response(s) 862. The action plan execution component 725 may combine (e.g., aggregate, summarize, de-duplicate, etc.) multiple API responses 862 to generate the action plan response data 838. In some examples, the action plan response data 838 may be the same or similar to the API response(s) 862. In some examples, the action plan response data 838 may include an identifier associated with the responding component 760 that provided the API response 862. For example, the (additional/second) action plan response data 838 may include first weather information from a first weather skill component, second weather information from a second weather skill component, third weather information from a search engine component, etc. In some embodiments, the action plan execution component 725 may remove/filter information from the API response 862 that is determined to include information not beneficial to the processing by the language model 745.

The action plan execution component 725 may send (step 11) the (additional/second) action plan response data 838 to the prompt generation component 740. The information from the API response(s) 862 may be included, by the prompt generation component 740, in a (additional/second) prompt to the language model 745. The prompt generation component 740 may generate the second prompt 842 to include the action plan response data 838 or a representation thereof. The second prompt 842 may also include information from the prior/first prompt (from step 6). For example, the second prompt 842 may include the user input data 727 (or a representation thereof), the relevant information for processing the user input data 727 (e.g., relevant context data, relevant API information, relevant exemplars, etc.), the processing stages information, and the action plan response data 838 (from step 11). In some embodiments, the second prompt 842 may also include at least a portion of the LM response 846 generated during a prior iteration of processing (e.g., the outputs based on performing the task generation stage and the action generation stage) to indicate actions/results of the prior iteration of processing by the language model 745. The second prompt 842 may include an indicator (e.g., label, identifier, etc.) associated with the action plan response data 838 to indicate, to the language model 745, that the string of characters/tokens following the indicator represent information determined based on performance of the actions determined during the action generation stage.

The second prompt 842 may be sent (step 12) to the language model 745 for processing. At this point, the language model 745 may perform the action generation stage of processing the results of the performed actions, which may involve interpreting or understanding the results included in the action plan response data 838. The language model 745 may generate (step 13) a (additional/second) LM response 846 based on the second prompt 842. The second prompt 842 may include a request or directive to the language model 745 to perform further processing with respect to the user input data 727. As described above, the second prompt 842 may provide, among other things, responses/results of performance of the action determined by the language model 745 determined during the prior iteration of processing. The language model 745 may generate further actions to be performed to respond to the user input data 727 (as part of the action generation stage) or may generate a (final/user-facing) response to the user input data 727 (as part of the response generation stage).

An example second prompt 842 may be:
{
Please process the following user input and context data to determine at least one action or API to execute and generate a response to the user.
First determine a task to perform (use “Task” label), then determine an API to perform the task (use “Action” label), then process the results from the API, and then generate a response to the user input (use “Response” label). You may determine multiple tasks to perform. You may have to process iteratively.
User: Turn on living room TV
Available context:
User devices: “living room TV”=[device id]
“living room TV” device state=Off
Available APIs:
TurnOn.device (device)
Turn VolumeUp.device (device)
SetTVChannel (device, input channel)
Prior Iteration:
Action: TurnOn.device (device=“living room TV”)
TurnOn.device (device=“living room TV”); API response: “living room TV” device state=ON
}

Based on the above example prompt 842, an example LM response 846 may be:
{
Task: User wants to turn on living room TV that is operation of a user device.
Action: I need an API to operate a device. TurnOn.device (device=“living room TV”)
Action result is “living room TV” device state=ON
Response: The living room TV is on now. Can I help you with anything else?
}

As described herein, the language model 745 may generate the LM response 846 on tokens-by-tokens basis. As such, in some examples, the second LM response 846 may include additional tokens (e.g., newly generated tokens) to the first LM response 846 (from step 7). In other examples, the second LM response 846 may include different tokens than the first LM response 846, where the currently generated tokens may represent outputs for further steps of the action generation stage and/or the response generation stage.

The language model 745 may determine further actions/APIs to be performed in a similar manner as described above. Such further actions/APIs may be based on any tasks, included in the task list generated during the task generation stage, that are still to be performed (e.g., a first task of booking a flight may be done, now a second task of booking a hotel is to be performed). Additionally or alternatively, the further actions/APIs may be based on the results included in the action plan response data 838 (at step 11) (e.g., an API response from a responding component 760 may indicate that additional information is needed to perform an action).

The language model 745 may determine a (final) response to the user input, where the response is to be presented to the user 705 via the user device 710. In other cases, the response may be presented via another user device 710 associated with the user 705. The language model 745 may determine the final response based on the results included in the action plan response data 838 (from step 11). For example, the language model 745 may summarize the results, may combine the results, may generate an interpretation of the results, etc. In a non-limiting example, the language model 745 may combine weather information from two or more responding components (e.g., combine high/low temperature information from a first responding component with humidity information from a second responding component). In another non-limiting example, the language model 745 may interpret results from a knowledge base component to determine a response to the specific user query (e.g., from a biographical search result for a historical person, a birthplace and siblings information may be extracted to determine a response to a user query “tell me about [person's] childhood”).

In some examples, the language model 745 may generate the further action to be performed is requesting additional information from the user 705. Such further action, in some embodiments, may be labeled as “Response” so that the action plan generation component 750 may cause a request to be output to the user 705.

The second LM response 846 may be sent (step 13) to the action plan generation component 750, which may determine (step 14) the (additional/second) action plan data 852. In some examples, the second LM response 846 sent to the action plan generation component 750 may include further action(s)/API(s) to be executed, which may be labeled with “Action.” In some examples, the second LM response 846 may include a final response to the user input, which may be labeled with “Response.”

Based on the tokens corresponding to the “Action” label, the action plan generation component 750 may determine the action plan data 852 to include one or more actions, one or more API calls and/or one or more responding components 760 corresponding to the action(s)/API(s) determined by the language model 745.

Based on the tokens corresponding to the “Response” label, the action plan generation component 750 may determine the action plan data 852 to include one or more actions, one or more API calls and/or one or more responding components 760 to present the output tokens to the user 705 as a response to the user input. For example, the action plan data 852 may include an identifier for the SSG component 756 to cause the output tokens, generated by the language model 745, to be presented as synthesized speech. As another example, the action plan data 852 may include an identifier for the responding component 760 capable of generating outputs in more than one form (e.g., a multi-modal output component) to cause the tokens to be presented as synthesized speech, displayed text/graphics, and/or other types of outputs.

The (second) action plan data 852 may be sent (step 14) to the action plan execution component 725, and as described herein, the action plan execution component 725 may determine executable API calls based on the action plan data 852. If the action plan data 852 represents additional actions to be performed, then the action plan execution component 725 may cause the corresponding responding component(s) 760 to perform the additional action(s) and corresponding response(s) (e.g., API responses 862) may be communicated to the prompt generation component 740 (via the action plan execution component 725 and action plan response data 838) to initiate another iteration of processing by the language model 745 with respect to the user input data 727. If the action plan data 852 represents a response to be presented to the user 705, then the action plan execution component 725 may cause the corresponding responding component(s) 760 to determine output data (e.g., responsive output data 762 shown in FIG. 7) that may be presented via the user device 710. For example, the responsive output data 762 may be sent to the user device 710 via the orchestrator component or another system component(s) 720.

In some embodiments, when further actions are generated by the language model 745 to be performed with respect to the user input data 727, the language model orchestrator 730 may perform another iteration of processing, which may involve generating another prompt 842 to the language model 745, generating another LM response 846 that may be used to determine further action plan data 852. The language model 745 may generate tokens corresponding to the action generation stage and/or the response generation stage during the further iteration.

In some embodiments, when a final response is generated by the language model 745, further processing with respect to the user input data 727 by the language model orchestrator 730 may be ceased (e.g., processing with respect to the user input data 727 by the language model orchestrator 730 may be complete). The language model orchestrator 730 may process with respect to a subsequently received user input, which may or may not be part of the same dialog session as the prior/already processed user input data 727.

The responsive output data 762 may include one or more of output audio data representing synthesized speech, text data for display, image for display, graphics/icons for display, media (e.g., video, music, background music, notification sounds, etc.) for playback, and other data. In some embodiments, the responsive output data 762 may include placement information representing where (e.g., top banner, left portion, center of screen, overlay on current visual, etc.) on the display screen of the user device 710 the output data is to be displayed. In some embodiments, the responsive output data 762 may be determined/provided by the responding component 760. In some embodiments, another system component 720 may process the responsive output data 762 prior to sending to the user device 710 to ensure that the responsive output data is formatted for the particular user device 710.

Referring again to FIG. 7, as shown, the system component(s) 720 may include a compliance component 770. In some embodiments, the compliance component 770 may be included in the language model orchestrator component 730. In other embodiments, the compliance component 770 may be one of the responding components 760 and the action plan generation component 750 may cause the action plan execution component 725 to send an API request to the compliance component 770 when processing by the compliance component 770 is to be performed.

The compliance component 770 may be configured to determine whether an output of the language model 745 is appropriate for output to the user 705. In some embodiments, the compliance component 770 may be configured to process language model output (e.g., the LM response 846) representing outputs/tokens generated by the language model 745 during processing of the user input data 727. The model output may include tokens generated during the task generation stage, the action generation stage or the response generation stage. The compliance component 770 may also or instead determine whether an input to the language model 745 (e.g., a user request, an output of another system component of the system 100) is appropriate and/or that the input will result in the language model 745 generating an output that is appropriate to present to the user 705. For this determination, the compliance component 770 may process the user input data 727 or a portion or representation thereof. In some embodiments, the compliance component 770 may process other data (e.g., context data, user profile data, system configuration/policy data, etc.) to determine whether the generated response and/or the input is appropriate.

In some embodiments, the compliance component 770 may determine whether the model output/LM response 846 and/or the user input data 727 corresponds to training data used to configure the language model 745 (e.g., the model output or user input is semantically or lexically similar to the training data, the model output or user input corresponds to functionality (e.g., topics, categories, actions, etc.) that the model is trained for, etc.). Additionally or alternatively, the compliance component 770 may determine whether the model output/LM response 846 and/or the user input data 727 corresponds to one or more words or phrases determined to be confidential, sensitive, or offensive. Additionally or alternatively, the compliance component 770 may determine whether the user input or the model output corresponds to an inappropriate content category, which may include biased content (e.g., biased toward protected classes including gender, race, age, etc.), harmful content (e.g., violent content, self-harm, etc.), profanity, etc.

In some embodiments, the compliance component 770 may use one or more techniques to determine whether the model output or the user input is appropriate; such techniques may include a rules-engine, a word-based similarity determination, a machine learning model based determination (e.g., using a classifier to classify model output or user input to appropriate category or inappropriate category), etc.

In some embodiments, the compliance component 770 may process the user input data 727 when it is received by the language model orchestrator component 730 and in some cases may process in parallel to the language model orchestrator component 730. In some embodiments, the compliance component 770 may process the model output as the language model 745 generates the output tokens. In other embodiments, the compliance component 770 may process the model output after the language model 745 has generated tokens for a particular processing stage (e.g., after the task generation stage is completed, after the action generation stage is completed, after the response generation stage is completed, etc.).

If the compliance component 770 determines that the model output or the user input data 727 is appropriate, then the language model orchestrator component 730 may continue processing with respect to the user input data 727. If the compliance component 770 determines that the model output is not appropriate, then one or more remedial actions may be performed. One example remedial action may involve prompting the language model 745 to generate a new/modified model output. In such examples, additional prompt data may be determined, which may include the original prompt data, the initial model output, and an indication that the initial model output is not appropriate for output to the user 705. The additional prompt data may include a request or directive to the language model 745 to generate model output that is appropriate for output to the user 705. Another example remedial action may involve the system outputting a generic/template response (e.g., “Sorry, I can't help you with that” or “I cannot answer questions for [inappropriate category])”) or a request for a rephrased input (e.g., “can you rephrase that”).

In some embodiments, the compliance component 770 may cause the system to output a response indicating where (e.g., a source external to the system components 720) the included/outputted information may be found. For example, the response may include an indication of a source of the training data or the data (e.g., API response 862) that the response is based on (e.g., the indication may include a description of an owner of the intellectual property rights corresponding to the training data/the response information, a hyperlink to the source, etc.). In some embodiments the compliance component 770 may determine that the model generated response is based on (e.g., summarizing, using, similar to, etc.) data that protected by intellectual property rights (or other laws), and instead of outputting the language model generated response (e.g., LM response 846). In some embodiments the responsive output data 762 may include an indication of the intellectual property rights owner, may include access to a source of the data (e.g., website link), or may include a template response (e.g., “I cannot process this request” or “The requested data is protected by intellectual property rights”, etc.). In some embodiments, the compliance component 770 may determine that the user input data 727 involves processing data or outputting data that is protected by certain intellectual property rights (or other laws). An example of such a user input may be “write a story about [protected character]” or “draw an image of [protected character] doing [some action]”, where the owner of intellectual property rights in the [protected character] may not allow use, copying, or other operations. In response, the system may cease or prevent processing by the language model orchestrator 730 of the user input data 727, and the system may output a template response (e.g., “I cannot process this request” or “The requested data is protected by intellectual property rights”, etc.).

As shown in FIG. 7, the system component(s) 720 may include a personalized context component 765. In some embodiments, the personalized context component 765 may be included in the language model orchestrator component 730. In other embodiments, the personalized context component 765 may be one of the responding components 760 and the action plan generation component 750 may cause the action plan execution component 725 to send an API request to the personalized context component 765.

The personalized context component 765 may be configured to determine personalized context data including context data corresponding to the user input data 727 and/or the user 705. In some embodiments, the initial plan generation component 735 may request personalized context data to include in the prompt 842. In other embodiments, other system component(s) 720, such as the language model 745, may request personalized context data (e.g., to determine a personalized response to a user input). The personalized context data may include user preferences, past user inputs, past system outputs for past user inputs from the user 705, past skill/app usage, user-defined items, etc. The personalized context component 765 may infer user preferences from user-provided preferences, past user interactions by the user 705, information related to users similar to the user 705, etc. In some embodiments, the personalized context component 765 may employ one or more techniques to determine the personalized context data; such techniques may include using a rules-engine, using one or more machine learning models (including a generative model), topic determination techniques, neural retrieval search techniques, etc.

In examples, the personalized context component 765 may receive the user input data 727, task data representing a current task being performed/processed, and/or model output indicating that an ambiguity exists or additional information is needed to generate a response to the user input. The personalized context component 765 may receive a query in some examples, which may include an identifier for the user 705. In a non-limiting example, the personalized context component 765 may receive the following example requests: “Does the user prefer to use [Music Service 1] or [Music Service 2] for playing music,” or “What kind of music does the user like?” The personalized context component 765 determine example personalized context data including “The user prefers [Music Service 1]” or “The user likes [music genre]”).

In some embodiments, the language model 745 may be fine-tuned to perform a particular task(s). Fine-tuning of the language model(s) may be performed using one or more techniques. One example fine-tuning technique is transfer learning that involves reusing a pre-trained model's weights and architecture for a new task. The pre-trained model may be trained on a large, general dataset, and the transfer learning approach allows for efficient and effective adaptation to specific tasks. Another example fine-tuning technique is sequential fine-tuning where a pre-trained model is fine-tuned on multiple related tasks sequentially. This allows the model to learn more nuanced and complex language patterns across different tasks, leading to better generalization and performance. Yet another fine-tuning technique is task-specific fine-tuning where the pre-trained model is fine-tuned on a specific task using a task-specific dataset. Yet another fine-tuning technique is multi-task learning where the pre-trained model is fine-tuned on multiple tasks simultaneously. This approach enables the model to learn and leverage the shared representations across different tasks, leading to better generalization and performance. Yet another fine-tuning technique is adapter training that involves training lightweight modules that are plugged into the pre-trained model, allowing for fine-tuning on a specific task without affecting the original model's performance on other tasks. Some techniques may involve supervised fine-tuning (SFT), unsupervised fine-tuning, semi-supervised fine-tuning, or other types of learning.

In some embodiments, one or more of the system components 720 described herein may be configured to begin processing with respect to data as soon as the data or a portion of the data is available to the components (e.g., processing in a streaming fashion). Some system components may be generative components/models that can begin processing with respect to portions of data as they are available, instead of waiting to initiate processing after the entirety of data is available. For example, the language model 745 may start processing a first portion of the prompt 842 while the prompt generation component 740 determines a second/subsequent portion of the prompt 842. As another example, the action plan generation component 750 may start processing a first portion of the LM response 846 while the language model 745 is generating a second/subsequent portion of the LM response 846.

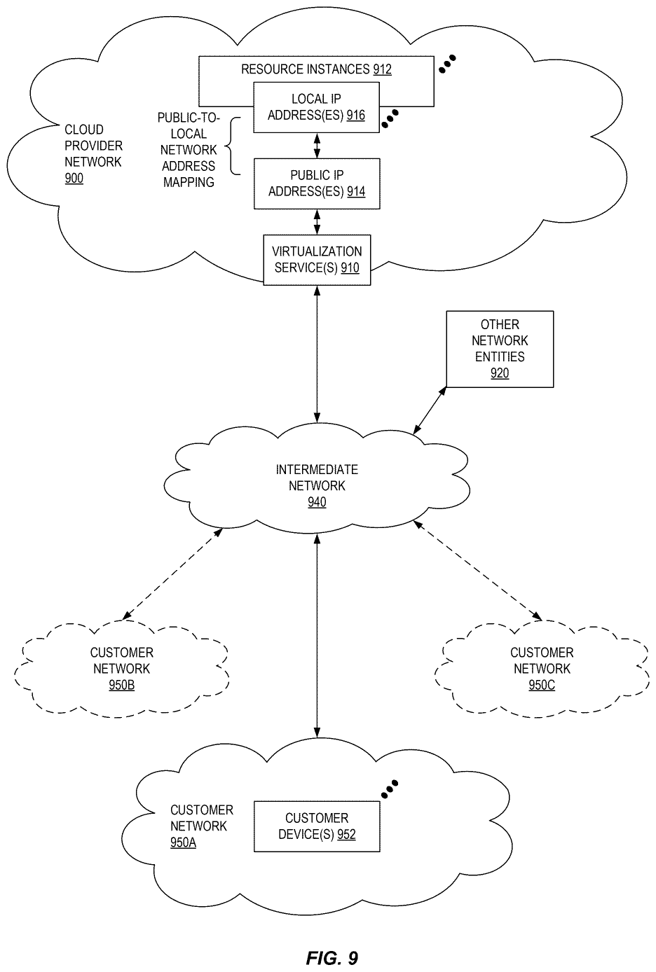

FIG. 9 illustrates an example multi-tenant provider network environment in which the techniques disclosed herein for using large language model as a theory solver are implemented. A provider network 900 can provide resource virtualization to customers via one or more virtualization services 910 that allow customers to purchase, rent, or otherwise obtain instances 912 of virtualized resources, including but not limited to computation and storage resources, implemented on devices within the provider network or networks in one or more data centers. Local Internet Protocol (IP) addresses 916 can be associated with the resource instances 912; the local IP addresses are the internal network addresses of the resource instances 912 on the provider network 900. In some examples, the provider network 900 can also provide public IP addresses 914 and/or public IP address ranges (e.g., Internet Protocol version 4 (IPv4) or Internet Protocol version 6 (IPv6) addresses) that customers can obtain from the provider network 900.

Conventionally, the provider network 900, via the virtualization services 910, can allow a customer of the service provider (e.g., a customer that operates one or more customer networks 950A-950C (or “client networks”) including one or more customer device(s) 952) to dynamically associate at least some public IP addresses 914 assigned or allocated to the customer with particular resource instances 912 assigned to the customer. The provider network 900 can also allow the customer to remap a public IP address 914, previously mapped to one virtualized computing resource instance 912 allocated to the customer, to another virtualized computing resource instance 912 that is also allocated to the customer. Using the virtualized computing resource instances 912 and public IP addresses 914 provided by the service provider, a customer of the service provider such as the operator of the customer network(s) 950A-950C can, for example, implement customer-specific applications and present the customer's applications on an intermediate network 940, such as the Internet. Other network entities 920 on the intermediate network 940 can then generate traffic to a destination public IP address 914 published by the customer network(s) 950A-950C; the traffic is routed to the service provider data center, and at the data center is routed, via a network substrate, to the local IP address 916 of the virtualized computing resource instance 912 currently mapped to the destination public IP address 914. Similarly, response traffic from the virtualized computing resource instance 912 can be routed via the network substrate back onto the intermediate network 940 to the source entity 920.

Local IP addresses, as used herein, refer to the internal or “private” network addresses, for example, of resource instances in a provider network. Local IP addresses can be within address blocks reserved by Internet Engineering Task Force (IETF) Request for Comments (RFC) 1918 and/or of an address format specified by IETF RFC 4193 and can be mutable within the provider network. Network traffic originating outside the provider network is not directly routed to local IP addresses; instead, the traffic uses public IP addresses that are mapped to the local IP addresses of the resource instances. The provider network can include networking devices or appliances that provide network address translation (NAT) or similar functionality to perform the mapping from public IP addresses to local IP addresses and vice versa.

Public IP addresses are Internet mutable network addresses that are assigned to resource instances, either by the service provider or by the customer. Traffic routed to a public IP address is translated, for example via 1:1 NAT, and forwarded to the respective local IP address of a resource instance.

Some public IP addresses can be assigned by the provider network infrastructure to particular resource instances; these public IP addresses can be referred to as standard public IP addresses, or simply standard IP addresses. In some examples, the mapping of a standard IP address to a local IP address of a resource instance is the default launch configuration for all resource instance types.

At least some public IP addresses can be allocated to or obtained by customers of the provider network 900; a customer can then assign their allocated public IP addresses to particular resource instances allocated to the customer. These public IP addresses can be referred to as customer public IP addresses, or simply customer IP addresses. Instead of being assigned by the provider network 900 to resource instances as in the case of standard IP addresses, customer IP addresses can be assigned to resource instances by the customers, for example via an API provided by the service provider. Unlike standard IP addresses, customer IP addresses are allocated to customer accounts and can be remapped to other resource instances by the respective customers as necessary or desired. A customer IP address is associated with a customer's account, not a particular resource instance, and the customer controls that IP address until the customer chooses to release it. Unlike conventional static IP addresses, customer IP addresses allow the customer to mask resource instance or availability zone failures by remapping the customer's public IP addresses to any resource instance associated with the customer's account. The customer IP addresses, for example, enable a customer to engineer around problems with the customer's resource instances or software by remapping customer IP addresses to replacement resource instances.

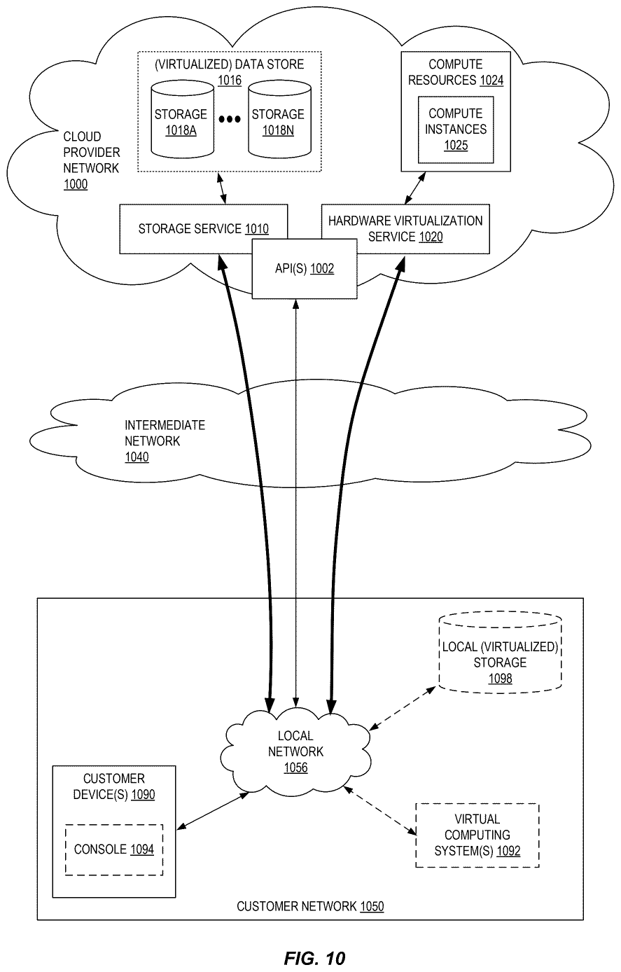

FIG. 10 is a block diagram of an example multi-tenant provider network that provides a storage service and a hardware virtualization service to customers and in which the techniques disclosed herein for large language model (LLM) verification. A hardware virtualization service 1020 provides multiple compute resources 1024 (e.g., compute instances 1025, such as VMs) to customers. The compute resources 1024 can, for example, be provided as a service to customers of a provider network 1000 (e.g., to a customer that implements a customer network 1050). Each computation resource 1024 can be provided with one or more local IP addresses. The provider network 1000 can be configured to route packets from the local IP addresses of the compute resources 1024 to public Internet destinations, and from public Internet sources to the local IP addresses of the compute resources 1024.

The provider network 1000 can provide the customer network 1050, for example coupled to an intermediate network 1040 via a local network 1056, the ability to implement virtual computing systems 1092 via the hardware virtualization service 1020 coupled to the intermediate network 1040 and to the provider network 1000. In some examples, the hardware virtualization service 1020 can provide one or more APIs 1002, for example a web services interface, via which the customer network 1050 can access functionality provided by the hardware virtualization service 1020, for example via a console 1094 (e.g., a web-based application, standalone application, mobile application, etc.) of a customer device 1090. In some examples, at the provider network 1000, each virtual computing system 1092 at the customer network 1050 can correspond to a computation resource 1024 that is leased, rented, or otherwise provided to the customer network 1050.

From an instance of the virtual computing system(s) 1092 and/or another customer device 1090 (e.g., via console 1094), the customer can access the functionality of a storage service 1010, for example via the one or more APIs 1002, to access data from and store data to storage resources 918A-918N of a virtual data store 1016 (e.g., a folder or “bucket,” a virtualized volume, a database, etc.) provided by the provider network 1000. In some examples, a virtualized data store gateway (not shown) can be provided at the customer network 1050 that can locally cache at least some data, for example frequently accessed or critical data, and that can communicate with the storage service 1010 via one or more communications channels to upload new or modified data from a local cache so that the primary store of data (the virtualized data store 1016) is maintained. In some examples, a user, via the virtual computing system 1092 and/or another customer device 1090, can mount and access virtual data store 1016 volumes via the storage service 1010 acting as a storage virtualization service, and these volumes can appear to the user as local (virtualized) storage 1098.

While not shown in FIG. 11, the virtualization service(s) can also be accessed from resource instances within the provider network 1000 via the API(s) 1002. For example, a customer, appliance service provider, or other entity can access a virtualization service from within a respective virtual network on the provider network 1000 via the API(s) 1002 to request allocation of one or more resource instances within the virtual network or within another virtual network.

FIG. 11 illustrates an example of a programmable electronic device that processes and manipulates data to perform tasks and calculations disclosed herein for large language model (LLM) verification. Example programmable electronic device 1100 includes electronic components encompassing hardware or hardware and software including processor 1102, memory 1104, auxiliary memory 1106, input device 1108, output device 1110, network interface 1114, and offload card 1124, all connected to bus 1116.

While only one of each type of component is depicted in FIG. 11 for the purpose of providing a clear example, multiple instances of any or all these electronic components may be present in device 1100. For example, multiple processors may be connected to bus 1116 in a particular implementation of device 1100. Accordingly, unless the context clearly indicates otherwise, reference with respect to FIG. 11 to a component of device 1100 in the singular such as, for example, processor 1102, is not intended to exclude the plural where, in a particular instance of device 1100, multiple instances of the electronic component are present. Further, some electronic components may not be present in a particular instance of device 1100. For example, device 1100 in a headless configuration such as, for example, when operating as a server racked in a data center, may not include, or be connected to, input device 1108 or output device 1110. As another example, offload card 1124 may be absent from device 1100 when not operating as a server racked in a data center as part of a cloud-based hosted compute service.

Processor 1102 is an electronic component that processes (e.g., executes, interprets, or otherwise processes) instructions 1118 including instructions 1120 for large language model (LLM) theory solver operation as described above. Processor 1102 may perform arithmetic and logic operations dictated by instructions 1118 and coordinate the activities of other electronic components of device 1100 in accordance with instructions 1118. Processor 1102 may fetch, decode, and execute instructions 1118 from memory 1104. Processor 1102 may include a cache used to store frequently accessed instructions 1118 to speed up processing. Processor 1102 may have multiple layers of cache (L1, L2, L3) with varying speeds and sizes. Processor 1102 may be composed of multiple cores where each such core is a processor within processor 1102. The cores may allow processor 1102 to process multiple instructions 1118 at once in a parallel processing manner. Processor 1102 may support multi-threading where each core of processor 1102 can handle multiple threads (multiple sequences of instructions) at once to further enhance parallel processing capabilities. Processor 1102 may be made using silicon wafers according to a manufacturing process (e.g., 7 nm, 5 nm, or 3 nm). Processor 1102 can be configured to understand and execute a set of commands referred to as an instruction set architecture (ISA) (e.g., x86, x86_64, or ARM).

Depending on the intended application, processor 1102 can be any of the following types of central processing units (CPUs): a desktop processor for general computing, gaming, content creation, etc.; a server processor for data centers, enterprise-level applications, cloud services, etc.; a mobile processor for portable computing devices like laptops and tablets for enhanced battery life and thermal management; a workstation processor for intense computational tasks like 3D rendering and simulations; or any other suitable type of CPU.

While processor 1102 can be a CPU, processor 1102, depending on the intended application, can be any of the following types of processors: a graphics processing unit (GPU) capable of highly parallel computation allowing for processing of multiple calculations simultaneously and useful for rendering images and videos and for accelerating machine learning computation tasks; a digital signal processor (DSP) designed to process analog signals like audio and video signals into digital form and vice versa, commonly used in audio processing, telecommunications, and digital imaging; specialized hardware for machine learning workloads, especially those involving tensors (multi-dimensional arrays); a field-programmable gate array (FPGA) or other reconfigurable integrated circuit that can be customized post-manufacturing for specific applications, such as cryptography, data analytics, and network processing; a neural processing unit (NPU) or other dedicated hardware designed to accelerate neural network and machine learning computations, commonly found in mobile devices and edge computing applications; an image signal processor (ISP) specialized in processing images and videos captured by cameras, adjusting parameters like exposure, white balance, and focus for enhanced image quality; an accelerated processing unit (APU) combing a CPU and a GPU on a single chip to enhance performance and efficiency, especially in consumer electronics like laptops and consoles; a vision processing unit (VPU) dedicated to accelerating machine vision tasks such as image recognition and video processing, typically used in drones, cameras, and autonomous vehicles; a microcontroller unit (MCU) or other integrated processor designed to control electronic devices, containing CPU, memory, and input/output peripherals; an embedded processor for integration into other electronic devices such as washing machines, cars, industrial machines, etc.; a system on a chip (SoC) such as those commonly used in smartphones encompassing a CPU integrated with other components like a graphics processing unit (GPU) and memory on a single chip; or any other suitable type of processor.

Memory 1104 is an electronic component that stores data and instructions 1118 that processor 1102 processes. Memory 1104 provides the space for the operating system, applications, and data in current use to be quickly reached by processor 1102. For example, memory 1104 may be a random-access memory (RAM) that allows data items to be read or written in substantially the same amount of time irrespective of the physical location of the data items inside memory 1104.

In some instances, memory 1104 is a volatile or non-volatile memory. Data stored in a volatile memory is lost when the power is turned off. Data in non-volatile memory remains intact even when the system is turned off. For example, memory 1104 can be Dynamic RAM (DRAM). DRAM such as Single Data Rate RAM (SDRAM) or Double Data Rate RAM (DDRAM) is volatile memory that stores each bit of data in a separate capacitor within an integrated circuit. The capacitors of DRAM leak charge and need to be periodically refreshed to avoid information loss. Memory 1104 can be Static RAM (SRAM). SRAM is volatile memory that is typically faster but more expensive than DRAM. SRAM uses multiple transistors for each memory cell but does not need to be periodically refreshed. Additionally, or alternatively, SRAM may be used for cache memory in processor 1102.

Device 1100 has auxiliary memory 1106 other than memory 1104. Examples of auxiliary memory 1106 include cache memory, register memory, read-only memory (ROM), secondary storage, virtual memory, memory controller, and graphics memory. Device 1100 may have multiple auxiliary memories including different types of auxiliary memories. Cache memory is found inside or very close to processor 1102 and is typically faster but smaller than memory 1104. Cache memory may be used to hold frequently accessed instructions 1118 (encompassing any associated data) to speed up processing. Cache memory may be hierarchical ranging from Level 1 cache memory which is the smallest but fastest cache memory and is typically inside processor 1102 to Level 2 and Level 3 cache memory which are progressively larger and slower cache memories that can be inside or outside processor 1102. Register memory is a small but very fast storage location within processor 1102 designed to hold data temporarily for ongoing operations. ROM is a non-volatile memory device that can only be read, not written to. For example, ROM can be a Programmable ROM (PROM), Erasable PROM (EPROM), or electrically erasable PROM (EEPROM). ROM may store basic input/output system (BIOS) instructions which help device 1100 boot up. Secondary storage is a non-volatile memory. For example, a secondary storage can be a hard disk drive (HDD) or other magnetic disk drive device; a solid-state drive (SSD) or other NAND-based flash memory device; an optical drive like a CD-ROM drive, a DVD drive, or a Blu-ray drive; or flash memory device such as a USB drive, an SD card, or other flash storage device. Virtual memory is a portion of a hard drive or an SSD that the operating system uses as if it were memory 1104. When memory 1104 gets filled, less frequently accessed data and instructions 1118 can be “swapped” out to the virtual memory. The virtual memory is slower than memory 1104, but it provides the illusion of having a larger memory 1104. A memory controller manages the flow of data and instructions 1118 to and from memory 1104. The memory controller can be located either on the motherboard of device 1100 or within processor 1102. Graphics memory is used by a graphics processing unit (GPU) and is specially designed to handle the rendering of images, videos, graphics, or performing machine learning calculations. Examples of graphics memory include graphics double data rate (GDDR) such as GDDR5 and GDDR6.

Input device 1108 is an electronic component that allows users to feed data and control signals into device 1100. Input device 1108 translates a user's action or the data from the external world into a form that device 1100 can process. Examples of input device 1108 include a keyboard, a pointing device (e.g., a mouse), a touchpad, a touchscreen, a microphone, a scanner, a webcam, a joystick/game controller, a graphics tablet, a digital camera, a barcode reader, a biometric device, a sensor, and a MIDI instrument.

Output device 1110 is an electronic component that conveys information from device 1100 to the user or to another device. The information can be in the form of text, graphics, audio, video, or other media representation. Examples of an output device 1110 include a monitor or display device, a printer device, a speaker device, a headphone device, a projector device, a plotter device, a braille display device, a haptic device, a LED or LCD panel device, a sound card, and a graphics or video card.

Network interface 1114 (sometimes referred to as a network interface card, NIC, network adapter, or network interface controller) is an electronic component that connects device 1100 to network 1122. Network interface 1114 functions to facilitate communication between device 1100 and network 1122. Examples of a network interface 1114 include an ethernet adaptor, a wireless network adaptor, a fiber optic adapter, a token ring adaptor, a USB network adaptor, a Bluetooth adaptor, a modem, a cellular modem or adapter, a powerline adaptor, a coaxial network adaptor, an infrared (IR) adapter, an ISDN adaptor, a VPN adaptor, and a TAP/TUN adaptor.

Bus 1116 is an electronic component that transfers data between other electronic components of or connected to device 1100. Bus 1116 serves as a shared highway of communication for data and instructions (e.g., instructions 1118), providing a pathway for the exchange of information between components within device 1100 or between device 1100 and another device. Bus 1116 connects the different parts of device 1100 to each other. For example, bus 1116 may encompass one or more of: a system bus, a front-side bus, a data bus, an address bus, a control bus, an expansion bus, a universal serial bus (USB), a I/O bus, a memory bus, an internal bus, an external bus, and a network bus.

Instructions 1118 are computer-processable instructions that can take different forms. Instructions 1118 can be in a low-level form such as binary instructions, assembly language, or machine code according to an instruction set (e.g., x86, ARM, MIPS) that processor 1102 is designed to process. Instructions 1118 can include individual operations that processor 1102 is designed to perform such as arithmetic operations (e.g., add, subtract, multiply, divide, etc.); logical operations (e.g., AND, OR, NOT, XOR, etc.); data transfer operations including moving data from one location to another such as from memory 1104 into a register of processor 1102 or from a register to memory 1104; control instructions such as jumps, branches, calls, and returns; comparison operations; and specialization operations such as handling interrupts, floating-point arithmetic, and vector and matrix operations. Instructions 1118 can be in a higher-level form such as programming language instructions in a high-level programming language such as Python, Java, C++, etc. Instructions 1118 can be in an intermediate level form in between a higher-level form and a low-level form such as bytecode or an abstract syntax tree (AST).

Instructions 1118 for processing by processor 1102 can be in different forms at the same or different times. For example, when stored in mass data storage 1112 or memory 1104, instructions 1118 may be stored in a higher-level form such as Python, Java, or other high-level programing language instructions, in an intermediate-level form such as Python or Java bytecode that is compiled from the programming language instructions, or in a low-level form such as binary code or machine code. When stored in processor 1102, instructions 1118 may be stored in a low-level form such as binary instructions, assembly language, or machine code according to an instruction set architecture (ISA). However, instructions 1118 may be stored in processor 1102 in an intermediate level form or even a high-level form where CPU 1102 can process instructions in such form.

Instructions 1118 may be processed by one or more processors of device 1100 using different processing models including any or all of the following processing models depending on the intended application: sequential execution where instructions are processed one after another in a sequential manner; pipelining where pipelines are used to process multiple instruction phases concurrently; multiprocessing where different processors different instructions concurrently, sharing the workload; thread-level parallelism where multiple threads run in parallel across different processors; simultaneous multithreading or hyperthreading where a single processor processes multiple threads simultaneously, making it appear as multiple logical processors; multiple instruction issue where multiple instruction pipelines allow for the processing of several instructions during a single clock cycle; parallel data operations where a single instruction is used to perform operations on multiple data elements concurrently; clustered or distributed computing where multiple processors in a network (e.g., in the cloud) collaboratively process the instructions, distributing the workload across the network; graphics processing unit (GPU) acceleration where GPUs with their many processors allow the processing of numerous threads in parallel, suitable for tasks like graphics rendering and machine learning; asynchronous execution where processing of instructions is driven by events or interrupts, allowing the one or more processors to handle tasks asynchronously; concurrent instruction phases where multiple instruction phases (e.g., fetch, decode, execute) of different instructions are handled concurrently; parallel task processing where different processors handle different tasks or different parts of data, allowing for concurrent processing and execution; or any other suitable processing model.

Network 1122 is a collection of interconnected computers, servers, and other programmable electronic devices that allow for the sharing of resources and information. Network 1122 can range in size from just two connected devices to a global network (e.g., the internet) with many interconnected devices. Individual devices on network 1122 are sometimes referred to as “network nodes.” Network nodes communicate with each other through mediums or channels sometimes referred to as “network communication links.” The network communication links can be wired (e.g., twisted-pair cables, coaxial cables, or fiber-optic cables) or wireless (e.g., Wi-Fi, radio waves, or satellite links). Network 1122 may encompass network devices such as routers, switches, hubs, modems, and access points. Network nodes may follow a set of rules sometimes referred to “network protocols” that define how the network nodes communicate with each other. Example network protocols include data link layer protocols such as Ethernet and Wi-Fi, network layer protocols such as IP (Internet Protocol), transport layer protocols such as TCP (Transmission Control Protocol), application layer protocols such as HTTP (Hypertext transfer Protocol) and HTTPS (HTTP Secure), and routing protocols such as OSPF (Open Shortest Path First) and BGP (Border Gateway Protocol). Network 1122 may have a particular physical or logical layout or arrangement sometimes referred to as a “network topology.” Example network topologies include bus, star, ring, and mesh. Network 1122 can be different of different sizes and scopes. For example, network 1122 can encompass some or all of the following categories of networks: a personal area network (PAN) that covers a small area (a few meters), like a connection between a computer and a peripheral device via Bluetooth; a local area network (LAN) that covers a limited area, such as a home, office, or campus; a metropolitan area network (MAN) that covers a larger geographical area, like a city or a large campus; a wide area network (WAN) that spans large distances, often covering regions, countries, or even globally (e.g., the internet); a virtual private network (VPN) that provides a secure, encrypted network that allows remote devices to connect to a LAN over a WAN; an enterprise private network (EPN) build for an enterprise, connecting multiple branches or locations of a company; or a storage area network (SAN) that provides specialized, high-speed block-level network access to storage using high-speed network links like Fibre Channel.

Device 1100 includes offload card 1124. Offload card 1124 includes its own processor 1126. Although not depicted in FIG. 11, offload card 1124 may also include network interface 1114. Offload card 1124 may be connected to bus 1116 via a Peripheral Component Interconnect-Express (PCI-E) standard or another suitable interconnect standard such as, for example, a QuickPath interconnect (QPI) standard or an UltraPath interconnect (UPI) standard. Device 1100 may include offload card 1124 when device 1100 acts as a host electronic device such as, for example, when operating as part of a hosted compute service. In this case, device 1100 hosts compute instances such as, for example, virtual machine instances or application container instances and offload card 1124 and processor 1126 run a hosted compute manager application that can manage the hosted compute instances that run on device 1100 and processor 1102. For example, the hosted compute manager application may perform hosted compute instance management operations, such as pausing or un-pausing hosted compute instances, launching or terminating hosted compute instances, performing memory transfer/copying operations, or other suitable hosted compute instance management operations. These management operations can, in some instances, be performed by the hosted compute manager application in coordination with a hypervisor (e.g., upon a request from the hypervisor) that runs on device 1100 and processor 1102. However, in some instances the hosted compute manager application is configured to process requests from other entities (e.g., from the hosted compute instances themselves), and does not coordinate with a hypervisor on device 1100.

A Large Language Model (LLM) is a neural network architecture, which may be based on the Transformer framework, designed for advanced natural language processing tasks. At its core, an LLM may begin with a tokenization process, employing algorithms like Byte Pair Encoding or WordPiece to break down input text into subword units. These tokens are then transformed into high-dimensional vector representations called embeddings, which capture semantic relationships between words.

The model's architecture may be centered around multi-head self-attention mechanisms, which allow it to analyze relationships between all tokens in a sequence, facilitating the capture of long-range dependencies. This may be complemented by feed-forward neural networks, layer normalization, and residual connections. The self-attention layers may enable the model to focus on different parts of the input when processing each token, while the feed-forward networks further transform these representations.

LLMs may be pre-trained on massive datasets, learning general linguistic patterns and world knowledge. This pre-training phase may involve objectives like masked language modeling or next-token prediction. The models may then be fine-tuned for specific tasks through transfer learning.

The architecture's scale may be a defining feature, with models often containing billions of parameters. This vast parameter count, combined with sophisticated input representations and efficient training techniques, may enable LLMs to capture intricate language patterns and generate coherent, contextually relevant text across various domains. The output may be produced through a layer that generates probability distributions over the vocabulary, with decoding techniques like beam search or nucleus sampling may be used to produce the text output.

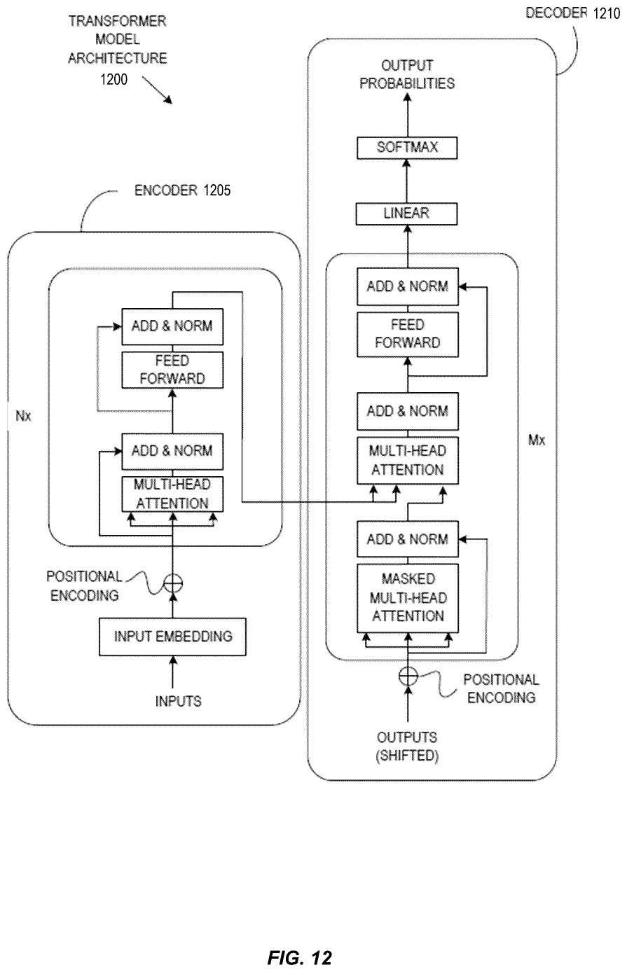

FIG. 12 illustrates an example Transformer model architecture 1200 that may be used in an implementation of an LLM, according to some embodiments of the present disclosure.

The Transformer model architecture 1200 may be a neural network design for natural language processing. At its core, the Transformer 1200 may encompass an encoder 1205 and a decoder 1210, both leveraging self-attention mechanisms. The architecture 1200 may begin with an input embedding layer that converts tokens into high-dimensional vector representations, which may range, for example, from 128 to 1024 dimensions. These embeddings may be augmented with positional encodings to retain sequence order information.

The Transformer 1200 may include a multi-head self-attention mechanism. This may allow the model 1200 to simultaneously attend to different parts of the input sequence, capturing various types of relationships and dependencies. Each attention head may compute query, key, and value vectors, enabling the model to focus on relevant parts of the input when processing each token. Following the attention layers, the architecture 1200 may incorporate feed-forward neural networks with multiple layers and non-linear activation functions.

A masked multi-head attention mechanism in the decoder 1210 of a Transformer model 1200 may be designed to prevent the model from attending to future tokens during sequence generation. In this mechanism, multiple attention heads may operate in parallel, each computing query (Q), key (K), and value (V) matrices from the input embeddings. The attention scores may be calculated as the dot product of Q and K, scaled by the inverse square root of the dimension of the keys. A lower triangular mask may be applied to these attention scores before softmax normalization, effectively setting all upper triangular elements to negative infinity. This masking may ensure that each position can only attend to previous positions in the sequence, maintaining the autoregressive property of the decoder. The masked attention scores may then be used to compute a weighted sum of the value vectors. The outputs from all heads may be concatenated and linearly transformed to produce the attention output. This process may allow the decoder to generate tokens sequentially while considering only the previously generated tokens, thus preserving the causal nature of language modeling.

To maintain stable training and mitigate vanishing gradients, the Transformer 1200 may employ layer normalization after each sub-layer (self-attention and feed-forward networks) and may introduce residual connections. These residual connections may allow unimpeded information flow through the network. The model may consist of multiple such encoder and decoder layers stacked on top of each other, increasing its capacity to learn complex language patterns.

The output layer may involve a linear transformation followed by a softmax function, producing probability distributions over the vocabulary for text generation tasks. This architecture 1200's design may allow for efficient parallel processing of input sequences, making it particularly suitable for handling the extensive datasets used in training LLMs.

As used herein and in the appended claims, the term “computer-readable media” refers to one or more mediums or devices that store or transmit information in a format that a computer system accesses. Computer-readable media encompasses both storage media and transmission media. Storage media includes volatile and non-volatile memory devices such as RAM devices, ROM devices, secondary storage devices, register memory devices, memory controller devices, graphics memory devices, and the like. Transmission media includes wired and wireless physical pathways that carry communication signals such as twisted pair cable, coaxial cable, fiber optic cable, radio waves, microwaves, infrared, visible light communication, and the like.

As used herein and in the appended claims, the term “non-transitory computer-readable media” encompasses computer-readable media as just defined but excludes transitory, propagating signals. Data stored on non-transitory computer-readable media isn't just momentarily present and fleeting but has some degree of persistence. For example, instructions stored in a hard drive, a SSD, an optical disk, a flash drive, or other storage media are stored on non-transitory computer-readable media. Conversely, data carried by a transient electrical or electromagnetic signal or wave is not stored in non-transitory computer-readable media when so carried.

As used herein and in the appended claims, unless otherwise clear in context, the terms “comprising,” “having,” “containing,” “including,” “encompassing,” “in response to,” “based on,” and the like are intended to be open-ended in that an element or elements following such a term is not meant to be an exhaustive listing of elements or meant to be limited to only the listed element or elements.

Unless otherwise clear in context, relational terms such as “first” and “second” are used herein and in the appended claims to differentiate one thing from another without limiting those things to a particular order or relationship. For example, unless otherwise clear in context, a “first device” could be termed a “second device.” The first and second devices are both devices, but not the same device.

Unless otherwise clear in context, the indefinite articles “a” and “an” are used herein and in the appended claims to mean “one or more” or “at least one.” For example, unless otherwise clear in context, “in an embodiment” means in at least one embodiment, but not necessarily more than one embodiment. Accordingly, unless otherwise clear in context, phrases such as “a device configured to” are intended to include one or more recited devices. Such one or more recited devices, unless otherwise clear in context, are collectively configured to carry out the stated recitations. For example, “a processor configured to carry out recitations A, B and C” encompasses both (a) a single processor configured to carry out recitations A, B, and C and (b) a first processor configured to carry out recitation A working in conjunction with a second processor configured to carry out recitations B and C.

Unless otherwise clear in context, the terms “set,” and “collection” should generally be interpreted to include one or more described items throughout this application. Accordingly, unless otherwise clear in context, phrases such as “a set of devices configured to” or “a collection of devices configured to” are intended to include one or more recited devices. Such one or more recited devices, unless otherwise clear in context, are collectively configured to carry out the stated recitations. For example, “a set of servers configured to carry out recitations A, B and C” encompasses both (a) a single server configured to carry out recitations A, B, and C and (b) a first server configured to carry out recitations A and B working in conjunction with a second server configured to carry out recitation C.

As used herein, unless otherwise clear in context, the term “or” is open-ended and encompasses all possible combinations, except where infeasible. For example, if it is stated that a component includes A or B, then, unless infeasible or otherwise clear in context, the component includes at least A, or at least B, or at least A and B. As a second example, if it is stated that a component includes A, B, or C then, unless infeasible or otherwise clear in context, the component includes at least A, or at least B, or at least C, or at least A and B, or at least A and C, or at least B and C, or at least A and B and C.

Unless the context clearly indicates otherwise, conjunctive language in this description and in the appended claims such as the phrase “at least one of X, Y, and Z,” is to be understood to convey that an item, term, etc. is either X, Y, or Z, or a combination thereof. Thus, such conjunctive language does not require that at least one of X, at least one of Y, and at least one of Z to each be present.

Unless the context clearly indicates otherwise, the relational term “based on” is used in this description and in the appended claims in an open-ended fashion to describe a logical (e.g., a condition precedent) or causal connection or association between two stated things where one of the things is the basis for or informs the other without requiring or foreclosing additional unstated things that affect the logical or casual connection or association between the two stated things. Further, the phrase “based on” is intended to mean “based at least in part on” unless specifically stated otherwise.

Unless the context clearly indicates otherwise, the relational term “in response to” or “responsive to” is used in this description and in the appended claims in an open-ended fashion to describe a stated action or behavior that is done as a reaction or reply to a stated stimulus without requiring or foreclosing additional unstated stimuli that affect the relationship between the stated action or behavior and the stated stimulus.

What is claimed is:

1. A computer-implemented method comprising:
receiving a natural language query requesting a first output;
processing the natural language query using a large language model (LLM) to determine:
a first logical representation of a first constraint of the natural language query, the first constraint corresponding to a first variable, and
a second logical representation of a second constraint of the natural language query, the second constraint corresponding to a second variable;
processing the first logical representation and the second logical representation to determine that a potential solution to the natural language query exists that satisfies both the first constraint and the second constraint;
determining a logical statement representing the natural language query including the first constraint and the second constraint, wherein the logical statement comprises the first variable and the second variable;
processing the logical statement to determine a first natural language representation of the logical statement;
determining a first prompt including the first natural language representation; and
processing the first prompt using the LLM to determine output text responsive to the natural language query, the output text including a first value for the first variable and a second value for the second variable.

2. The computer-implemented method of claim 1, wherein:
determining the logical statement comprises processing the first logical representation and the second logical representation using a satisfiability modulo theory solver component to determine the logical statement.

3. The computer-implemented method of claim 2, wherein:
determining that a potential solution to the natural language query exists comprises processing the first logical representation and the second logical representation using the satisfiability modulo theory solver component to determine that at least one potential first value exists for the first variable and at least one potential second value exists for the second variable such that the logical statement is satisfied.

4. The computer-implemented method of claim 1, further comprising:
determining a domain corresponding to the natural language query;
determining first data corresponding to the domain, the first data relevant for responding to the natural language query; and
determining the first prompt further including a natural language representation of the first data.

5. A computer-implemented method comprising:
receiving a natural language input requesting a first output based on a first constraint;
determining a first conditional statement corresponding to the first constraint and a first variable associated with the first constraint;
determining a first prompt including the natural language input, the first conditional statement and a first request to determine at least a first value for the first variable, wherein the first value satisfies the first conditional statement;
processing, using a first language model, the first prompt to generate at least the first value; and
causing presentation of the first value in response to the natural language input.

6. The computer-implemented method of claim 5, further comprising:
determining a second prompt including the natural language input and a second request to generate at least one conditional statement for determining at least one value for the first output; and
processing, using a second language model, the second prompt to generate the first conditional statement.

7. The computer-implemented method of claim 5, further comprising:
determining a second prompt including the natural language input, and a second request to generate at least one variable relevant for determining at least one value for the first output based on the first constraint; and
processing, using a second language model, the second prompt to generate the first variable.

8. The computer-implemented method of claim 5, further comprising:
determining that the natural language input corresponds to a type of conditional statement; and
based on the natural language input corresponding to the type of conditional statement, using a component configured to process a constraint satisfaction problem to determine the first conditional statement.

9. The computer-implemented method of claim 5, further comprising:
processing, using the first language model, the first prompt to generate at least the first value and a confidence value corresponding to the first value;
based on the confidence value satisfying a condition, determining a second conditional statement corresponding to the first constraint and the first variable;
determining a second prompt including the natural language input, the second conditional statement, the first value and a second request to determine at least a second value for the first variable, wherein the second value is different than the first value; and
processing, using the first language model, the second prompt to generate at least the second value.

10. The computer-implemented method of claim 5, further comprising:
determining a domain corresponding to the natural language input;
determining data corresponding to the domain and relevant for responding to the natural language input; and
determining at least the first variable based on the data.

11. The computer-implemented method of claim 5, further comprising:
determining context data corresponding to the natural language input; and
determining the first conditional statement based on the context data.

12. The computer-implemented method of claim 5, further comprising:
determining data relevant for processing the natural language input; and
determining the first prompt to further include the data.

13. A system comprising:
at least one processor; and
at least one memory including instructions that, when executed by the at least one processor, cause the system to:
receive a natural language input requesting a first output based on a first constraint;
determine a first conditional statement corresponding to the first constraint and a first variable associated with the first constraint;
determine a first prompt including the natural language input, the first conditional statement and a first request to determine at least a first value for the first variable, wherein the first value satisfies the first conditional statement;
process, using a first language model, the first prompt to generate at least the first value; and
cause presentation of the first value in response to the natural language input.

14. The system of claim 13, wherein the at least one memory includes further instructions that, when executed by the at least one processor, further cause the system to:
determine a second prompt including the natural language input and a second request to generate at least one conditional statement for determining at least one value for the first output; and
process, using a second language model, the second prompt to generate the first conditional statement.

15. The system of claim 13, wherein the at least one memory includes further instructions that, when executed by the at least one processor, further cause the system to:
determine a second prompt including the natural language input, and a second request to generate at least one variable relevant for determining at least one value for the first output based on the first constraint; and
process, using a second language model, the second prompt to generate the first variable.

16. The system of claim 13, wherein the at least one memory includes further instructions that, when executed by the at least one processor, further cause the system to:
determine that the natural language input corresponds to a type of conditional statement; and
based on the natural language input corresponding to the type of conditional statement, use a component configured to process a constraint satisfaction problem to determine the first conditional statement.

17. The system of claim 13, wherein the at least one memory includes further instructions that, when executed by the at least one processor, further cause the system to:
process, using the first language model, the first prompt to generate at least the first value and a confidence value corresponding to the first value;
based on the confidence value satisfying a condition, determine a second conditional statement corresponding to the first constraint and the first variable;
determine a second prompt including the natural language input, the second conditional statement, the first value and a second request to determine at least a second value for the first variable, wherein the second value is different than the first value; and
process, using the first language model, the second prompt to generate at least the second value.

18. The system of claim 13, wherein the at least one memory includes further instructions that, when executed by the at least one processor, further cause the system to:
determine a domain corresponding to the natural language input;
determine data corresponding to the domain and relevant for responding to the natural language input; and
determine at least the first variable based on the data.

19. The system of claim 13, wherein the at least one memory includes further instructions that, when executed by the at least one processor, further cause the system to:
determine context data corresponding to the natural language input; and
determine the first conditional statement based on the context data.

20. The system of claim 13, wherein the at least one memory includes further instructions that, when executed by the at least one processor, further cause the system to:
determine data relevant for processing the natural language input; and
determine the first prompt to further include the data.
